(19) United States
(12) Patent Application Publication
(10) Pub. No.: US 2007/0081470 A1
(43) Pub. Date: Apr. 12, 2007

(54) Information management device, information management system, and computer usable medium

(75) Inventors: Satoru Yanagi, Nagoya-shi (JP); Kazushige Muroi, Nagoya-shi (JP); Kazuma Aoki, Kasugai-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/528,343

(22) Filed: Sep. 28, 2006

(30) Foreign Application Priority Data
Sep. 30, 2005 (JP) P2005-288540

(51) Int. Cl. H04J 1/16

(52) U.S. Cl. 370/252

(57) ABSTRACT

The same utilization data specifying information as utilization data specifying information for specifying one utilization data is extracted from a first storage unit (first extraction). Process specifying information correlated with the extracted utilization data specifying information is selectively extracted every type of a processing operation (second extraction). The same process specifying information as the process specifying information extracted in the second extraction is extracted from the first storage unit in the unit of type of a processing operation (third extraction). When a utilization time correlated with the process specifying information extracted in the third extraction is included in a predetermined time before and after a utilization time correlated with the process specifying information extracted in the second extraction, the utilization data specified by the utilization specifying information correlated with the process specifying information extracted in the third extraction is correlated with the one utilization data.

### CROSS REFERENCE TO RELATED APPLICATION

This application claims priority from Japanese Patent Application No. 2005-288540 filed Sep. 30, 2005, the contents of which are hereby incorporated by reference into the present application.

### TECHNICAL FIELD

Aspects of the present invention relate to an information management system for managing a plurality of information pieces or data as a management target, an information management device included in the information management system, and a program associated with the information management device.

### BACKGROUND

In recent years, personal computers (hereinafter, referred to as “PC”) have been widely spread and used for a personal purpose or on business. For example, a PC is connected to an external device serving as an information input source or an external device for performing an operation based on a command from the PC in a communication-practicable manner. Specifically, the PC is supplied with a large amount of data from the external devices and the information is used and managed by the PC, while the processes based on the managed information are performed to the external devices. In the environment in which it is difficult to install a plurality of external devices corresponding to the processes, a so-called multifunction machine having a plurality of units that execute a plurality of functions is connected to the PC.

The PC and the external devices transmit and receive a large amount of information therebetween in association with operations of the external devices, and the large amount of information is managed by the PC (for example, see JP-A-2004-32085).

In the PC for managing a large amount of data, there have been suggested techniques of correlating data with each other so as to enhance the efficiency of works using the data to be managed.

For example, there is known an information management system which can perform the correlating operation by allowing a message requesting for an instruction of correlating conditions to be displayed and allowing a user to give an instruction in response to the display so as to correlate one data to be written or one data previously written with another data and which can display the another data correlated with the one data at the time of utilizing the one data (for example, see JP-A-2000-315203).

### SUMMARY

Aspects of the present invention provide an information management system which can give a correlation to data as a target of a process performed with one purpose, an information management device included in the information management system, and a program for performing a predetermined operation to the information management device.

### BRIEF DESCRIPTION OF THE DRAWINGS

FIG. 1 is a diagram illustrating a configuration of an information management system according to an illustrative aspect of the present invention;

FIG. 2 is a diagram illustrating a status table according to an illustrative aspect of the invention;

FIG. 3 is a diagram illustrating definitions of items stored in the status table according to a first illustrative aspect of the invention;

FIG. 4 is a diagram illustrating a document table according to an illustrative aspect of the invention;

FIG. 5 is a diagram illustrating a file information table according to an illustrative aspect of the invention;

FIG. 6 is a diagram illustrating a device designating table according to an illustrative aspect of the invention;

FIG. 7 is a diagram illustrating a flow of a main process performed by a PC according to an illustrative aspect of the invention;

FIG. 8 is a diagram illustrating a flow of a before-activation intellectual assistance process according to an illustrative aspect of the invention;

FIG. 9 is a diagram illustrating a flow of a simultaneous print candidate search process according to an illustrative aspect of the invention;

FIG. 10 is a diagram illustrating a flow of an event document search process according to an illustrative aspect of the invention;

FIG. 11 is a diagram illustrating a flow of a simultaneous print candidate display process according to an illustrative aspect of the invention;

FIG. 12 is a diagram illustrating a display format of a search result of the simultaneous print candidate search process according to an illustrative aspect of the invention;

FIG. 13 is a diagram illustrating a flow of a during-activation intellectual assistance process according to the first illustrative aspect of the invention;

FIG. 14 is a diagram illustrating a flow of a GID search condition setting process according to the first illustrative aspect of the invention;

FIG. 15 is a diagram illustrating a flow of a document search process according to an illustrative aspect of the invention;

FIG. 16 is a diagram illustrating a flow of a search result display process according to an illustrative aspect of the invention;

FIG. 17 is a diagram illustrating a display format (associated with the status table) of a search result in the during-activation intellectual assistance process according to an illustrative aspect of the invention;

FIG. 18 is a diagram illustrating a display format (associated with the document table) of a search result in the during-activation intellectual assistance process according to an illustrative aspect of the invention;

FIG. 19 is a diagram illustrating a display format (associated with the status table) of a search result in the during-activation intellectual assistance process according to an illustrative aspect of the invention;

FIG. 20 is a diagram illustrating a display format (associated with the document table) of a search result in the during-activation intellectual assistance process according to an illustrative aspect of the invention;

FIG. 21 is a diagram illustrating a flow of a status table registration process according to an illustrative aspect of the invention;

FIG. 22 is a diagram illustrating a flow of a manual intellectual assistance process according to an illustrative aspect of the invention;

FIG. 23 is a diagram illustrating a flow of the manual intellectual assistance process according to an illustrative aspect of the invention;

FIG. 24 is a diagram illustrating a flow of a document intellectual assistance process according to an illustrative aspect of the invention;

FIG. 25 is a diagram illustrating a display format (associated with the status table) of a search result in the manual intellectual assistance process according to an illustrative aspect of the invention;

FIG. 26 is a diagram illustrating a display format (associated with the document table) of a search result in the manual intellectual assistance process according to an illustrative aspect of the invention;

FIG. 27 is a diagram illustrating a flow of a document table updating process according to an illustrative aspect of the invention; and

FIG. 28 is a diagram illustrating a flow of the during-activation intellectual assistance process according to a second illustrative aspect of the invention.

### DETAILED DESCRIPTION

General Overview

According to an aspect of the invention, there is provided an information management device comprising: a second storage unit that stores a plurality of utilization data; a utilization unit that utilizes the utilization data stored in the second storage unit; a specification unit that specifies a utilization time at which the utilization data are used by the utilization unit, utilization data specifying information for specifying the utilization data, and a process specifying unit that specifies a processing operation performed for the utilization data; a first storage unit that correlates and stores the utilization time, the utilization data specifying information, and the process specifying information specified by the specification unit; a first extraction unit that extracts the same utilization data specifying information as the utilization data specifying information for specifying one utilization data, which is utilized by the utilization unit, from the first storage unit; a second extraction unit that selectively extracts the process specifying information correlated with the utilization data specifying information extracted by the first extraction unit for each type of the processing operation; a third extraction unit that extracts the same process specifying information as the process specifying information extracted by the second extraction unit from the first storage unit in the unit of type of the processing operation; and a correlation giving unit that correlates the utilization data specified by the utilization data specifying information, which is correlated with the utilization time extracted by the third extraction unit, with the one utilization data when the utilization time correlated with the process specifying information extracted by the third extraction unit is included in a period obtained by adding a first predetermined period to the utilization time correlated with the process specifying information extracted by the second extraction unit and a period obtained by retroacting by a second predetermined period from the utilization time.

Accordingly, another utilization data having been processed in the same way within a predetermined period before and after a time when one utilization data was processed in the past can be correlated with the one utilization data. That is, by setting a period obtained by adding a predetermined period of time to before and after the processing time, another utilization data having been utilized only when one utilization data was utilized in the past can be correlated with the one utilization data and data having been subjected to the same process before and after the one utilization data is processed can be correlated with the one utilization data.

The “period” in the first or second predetermined period includes factors of time points.

According to another aspect of the invention, it is possible to give a correlation to data as a target of a process performed with one purpose.

According to still another aspect of the present invention, the same utilization data specifying information as utilization data specifying information for specifying one utilization data is extracted from a first storage unit (first extraction). Process specifying information correlated with the extracted utilization data specifying information is selectively extracted every type of a processing operation (second extraction). The same process specifying information as the process specifying information extracted in the second extraction is extracted from the first storage unit in the unit of type of a processing operation (third extraction). When a utilization time correlated with the process specifying information extracted in the third extraction is included in a predetermined time before and after a utilization time correlated with the process specifying information extracted in the second extraction, the utilization data specified by the utilization specifying information correlated with the process specifying information extracted in the third extraction is correlated with the one utilization data.

According to still another aspect of the invention, there is provided an information management system comprising: the information management device; and an external device which is connected to the information management device in a communication-practicable manner and which has a second output unit that performs a predetermined process, wherein the information management device has a first output unit that outputs the utilization data correlated with the utilization data by the correlation giving unit when the second output unit outputs the utilization data.

Accordingly, when an output process is performed to the second output unit, another utilization data having been subjected to the same process within a predetermined period before and after the time when the utilization data (output data) as an output target was processed in the past can be correlated with the output data and the correlated utilization data can be output. “When the second output unit output the utilization data” may be a time point when the output process is actually started or may be a time point when an output command is given.

According to still another aspect of the invention, it is possible to provide an information management system which can search out and output data correlated with data output from an output unit of an external device using activation of the external device as a trigger.

According to still another aspect of the invention, the utilization data output by the first output unit of the information management device may be output as address information from which the utilization data is specified and accessed, and the utilization data indicated by the address information may be output in response to selection of the address information.

Accordingly, it is possible to easily select and output correlated data.

According to still another aspect of the invention, since only desired data can be selected, it is possible to prevent unnecessary data from being output.

According to still another aspect of the invention, there is provided a computer usable medium having computer readable instructions stored thereon for enabling a computer to perform predetermined operations, the predetermined operations including the steps of: storing a plurality of utilization data in a second storage unit; utilizing the utilization data stored in the second storage unit; specifying a utilization time at which the utilization data are used, utilization data specifying information for specifying the utilization data, and a process specifying information that specifies a processing operation performed for the utilization data; first correlating and storing the specified utilization time, the utilization data specifying information, and the process specifying information; first extracting the same utilization data specifying information as the utilization data specifying information for specifying one utilization data, which is utilized, from the first storage unit; second extracting that selectively extracts the process specifying information correlated with the utilization data specifying information extracted by the first extracting for each type of the processing operation; third extracting that extracts the same process specifying information as the process specifying information extracted by the second extracting from the first storage unit for each type of the processing operation; and correlating the utilization data specified by the utilization data specifying information, which is correlated with the utilization time extracted by the third extracting, with the one utilization data when the utilization time correlated with the process specifying information extracted by the third extracting is included in a period obtained by adding a first predetermined period to the utilization time correlated with the process specifying information extracted by the second extracting and a period obtained by retroacting a second predetermined period from the utilization time.

Accordingly, another utilization data having been processed in the same way within a predetermined period before and after a time when one utilization data was processed in the past can be correlated with the one utilization data. That is, by setting a period obtained by adding a predetermined period of time to before and after the processing time, another utilization data having been utilized only when one utilization data was utilized in the past can be correlated with the one utilization data and data having been subjected to the same process before and after the one utilization data is processed can be correlated with the one utilization data.

According to still another aspect of the invention, it is possible to provide a program serving as the information management device.

### FIRST EXAMPLE

Hereinafter, a specific information management system according to an illustrative aspect of the invention will be described with reference to the drawings. The invention is not limited to the configuration described below, but may employ a variety of configurations within the same technical spirit.

(Configuration of Information Management System)

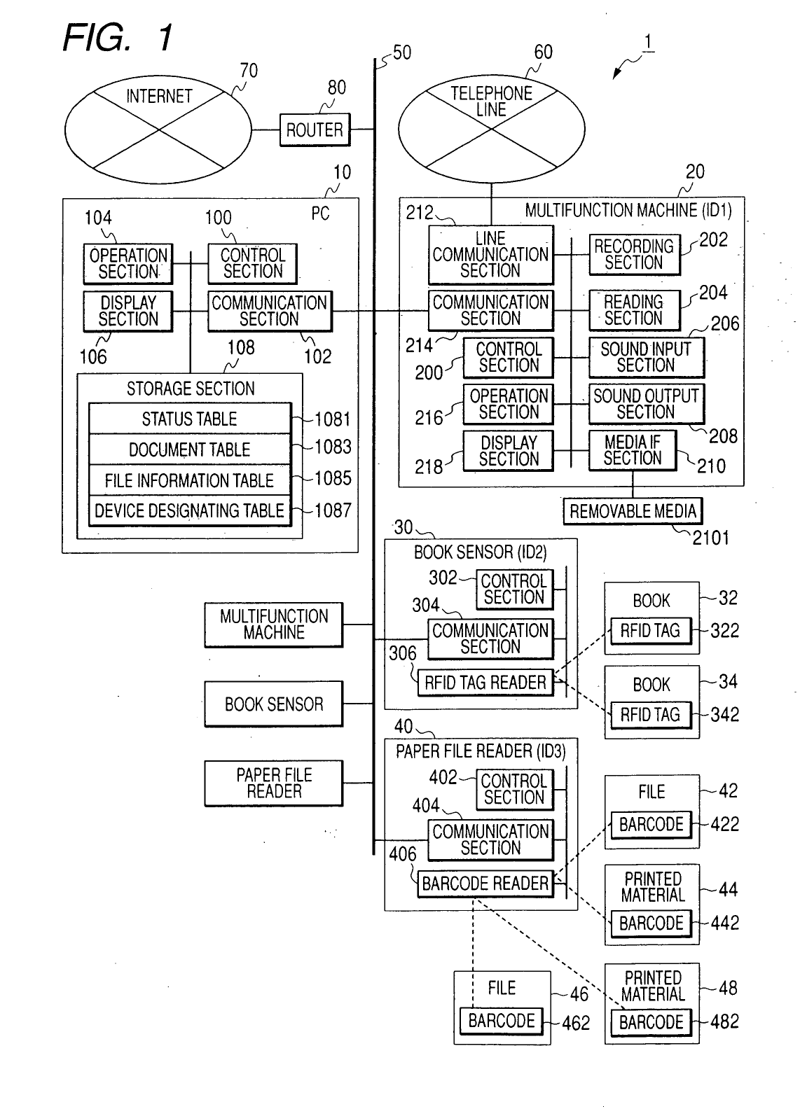

FIG. 1 is a diagram illustrating an information management system. As can be seen from the figure, the information management system 1 comprises a PC 10 as an information processing device comprising an information management function, a multifunction machine 20 as an external device for performing a variety of functions, a book sensor 30 as an external device for sensing books 32 and 34 as a management target of the PC 10, and a paper file reading section 40 as an external device for sensing paper files 42 and 46, which are stationery for filing paper as a management target of the PC 10, and printed materials 44 and 48. The devices are all connected to each other through a network line 50.

The PC 10 comprises a CPU, a ROM, and a RAM (not shown), and further comprises a control section 100 for controlling operations of the PC 10 (the entire PC 10) on the basis of programs stored in the ROM, a communication section 102, which is connected to the network line 50 so as to control the network line 50, an operation section 104 for receiving instructions from a user of the PC 10, a display section 106 for displaying a variety of information, and a storage section 108 comprising a hard disk or the like.

The storage section 108 comprises a status table 1081, a document table 1083, a file information table 1085, and a device designating table 1087. Details of the tables will be described later.

The multifunction machine 20 comprises a CPU, a ROM, and a RAM (not shown), and further comprises a control section 200 for controlling operations of the multifunction machine 20 (the entire multifunction machine 20), a recording section 202 as an image forming unit, a reading section 204 as an image reading unit, a sound input section 206 as a microphone, a sound output section 208 as a speaker, and a media IF section 210 fitted with a removable media 2101. The multifunction machine further comprises a line communication section, which is connected to a telephone line 60 so as to control the telephone line 60, a communication section 214, which is connected to the network line 50 so as to control the network line 50, an operation section 216 for receiving instructions from a user of the multifunction machine 20, and a display section 218 for displaying a variety of information.

A device ID (multifunction machine ID 1) indicating that it is a device constituting the information management system 1 is given to the multifunction machine 20.

The book sensor 30 comprises a CPU, a ROM, and a RAM (not shown), and further comprises a control section 302 for controlling operations of the book sensor 30 (the entire book sensor 30), a communication section 304, which is connected to the network line 50 so as to control the network line 50, and a radio-frequency (RF) ID tag reading section 306 for reading information of RFID tags 322 and 324 given to books 32 and 34.

The book sensor 30 serves as a device for storing information indicating what book is in a user's hands at what times (is being read or is ready to be read). That is, when the RFID tag read 306 is activated on the basis of the program stored in the ROM of the control section 302 and a response is read from the RFID tag 332 or 342 of the books 32 and 34, the identification information on the RFID tag 332 or 342 and the present time (start time) are temporarily stored in the RAM of the control section 302. Then, when the response read from the RFID tags 332 or 342 ends, the identification information on the RFID tag 332 or 342 and the start time temporarily stored in the RAM of the control section 302 and the present time (end time) are transmitted to the PC 10 through the communication section 304. The PC 10 stores the information in the statue table 1081.

A device ID (book sensor ID 2) indicating that it is a device constituting the information management system 1 is given to the book sensor 30.

The paper file reading section 40 comprises a CPU, a ROM, and a RAM (not shown), and further comprises a control section 402 for controlling operations of the paper file reading section 40 (the entire paper file reading section 40), a communication section 404 connected to the network line 50 so as to control the network line 50, and a barcode reading section 406 for reading barcodes 422, 442, 462, and 482 given to the paper files 42 and 46 or the printed materials 44 and 48. The paper file reading section 40 serves as an input section for forming information, which is used to correspond the paper files 42 and 46 with the printed materials 44 and 48 filed in the paper files, in a file information table 1085. That is, the paper file reading section inputs the barcodes of the paper files through the barcode reading section 406 on the basis of a program stored in a ROM of the control section 402, and then inputs the barcodes of the printed materials, in which the barcodes are temporarily stored in a RAM of the control section 402. The input data temporarily stored are transmitted to the PC 10 through the communication section 404. The PC 10 receives the information and adds the received information to the status table 1081 and the file information table 1085.

A device ID (paper file reading section ID 3) indicating that it is a device constituting the information management system 1 is given to the paper file reading section 40.

Now, information stored in the status table 1081, the document table 1083, the file information table 1085, and the device designating table 1087, which are all stored in the storage section 108 of the PC 10, will be described.

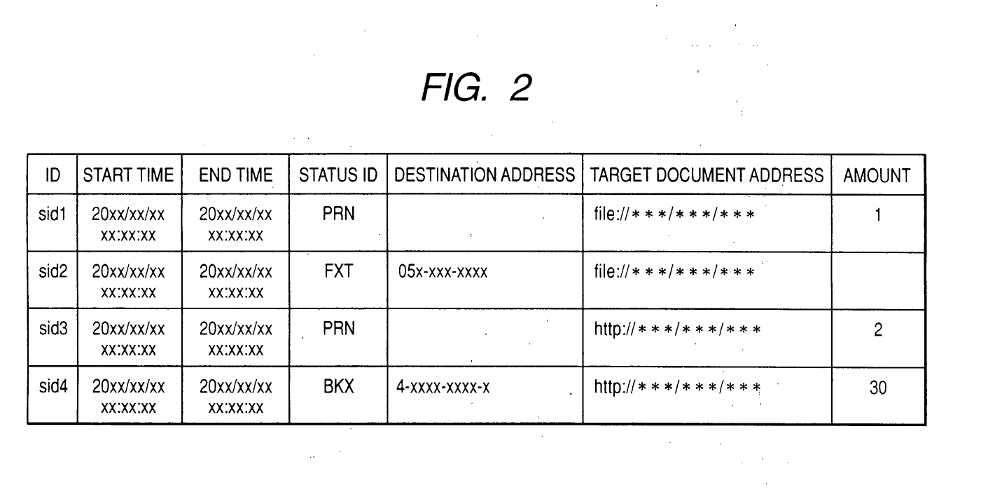

As shown in FIG. 2, the status table 1081 stores a processing operation (status ID) executed by an execution unit of the multifunction machine 20, start and end times of the processing operation (wherein it can be properly determined what time is set as the start time or the end time), information (hereinafter, referred to as “target document address”) indicating a location of a document which is a target of the processing operation (hereinafter, referred to as “target document”), an opposite address for specifying a specific opposite party when the processing operation is performed to the specific opposite party, and an amount of the target document which is a target of the processing operation, as one record every time when the processing operation is performed. A unique ID for identifying the processing operation is given to each processing operation.

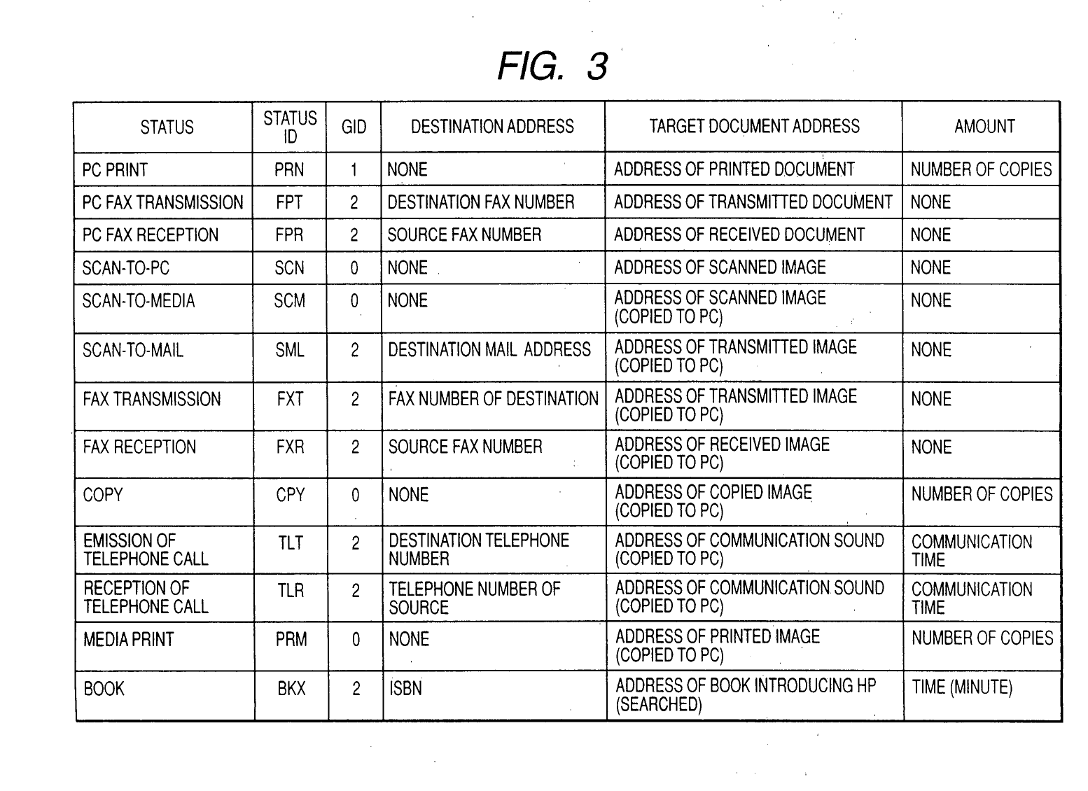

The status ID stored in the status table 1081 is defined as shown in FIG. 3. For example, when the PC 10 performs a print job using the recording section 202 of the multifunction machine 20 (this case is defined as a status “PC print” in FIG. 3), the status ID is set to “PRN”, the destination address is set to “None”, the target document address is set to “Address of printed document”, and the amount is set to “Number of copies.”

Since the PC print operation is performed between the PC 10 and the multifunction machine 20, the destination address is set to “None.” Since the document as a target of the processing operation is stored in the storage section 108 of the PC 10, an address of the storage section 108 storing the target document or an address of a homepage (hereinafter, referred to as “HP”) when the target document is a specific HP is stored as the target document address. The amount is set to the “Number of sheets.” For example, when a sheet of target document is printed, the amount is “one copy.”

When a facsimile (hereinafter, referred to as “fax”) transmission is performed using the reading section 204 and the line communication section 212 of the multifunction machine 20 (this case is defined as a status “fax transmission” in FIG. 3), the status ID is set to “FAX”, the destination address is set to “Destination FAX number”, the target document address is set to “Address of transmitted image (copied to PC)”, and the amount is set to “None.”

Since the fax transmission is performed between the multifunction machine 20 and a different facsimile machine, the destination address is set to “Destination FAX number.” In the information management system 1, when the fax transmission is performed, the transmitted image as a target of the fax transmission is stored in the storage section 108 of the PC 10. Accordingly, an address in the storage section 108 in which the transmitted image is stored (an address of the transmitted image (copied to the PC)) is defined as the “Target document address” (in the process (status) defined as “(copied to the PC)” in the target document address in FIG. 3, an address in the storage section 108 in which an image or sound is stored as a processing target as described above is defined as the target document address.).

When the books 32 and 34 managed by the PC 10 are used (this case is defined as a status “Book” in FIG. 3), the status ID is set to “BKX”, the destination address is set to “Japanese book code (hereinafter, referred to “ISBN”)”, the target document address is “Book introducing HP address (searched)”, and the amount is set to “time (minute).”

ISBN used as the destination address serves to identify the books 32 and 34 and is stored in RFID tags 322 and 342. The address of the HP introducing the books 32 and 34 is provided for a general purpose and is defined as the address stored as the target document address. The amount is set to the time (minute) for using the books 32 and 34.

In addition to those described above, “PC fax transmission (the pc transmits image data and destination to the multifunction machine 20 through the communication section 102 and the multifunction machine 20 fax transmits received image data through the line communication section 212)”, “PC fax reception (the line communication section 212 of the multifunction machine 20 transmits the received image data to the PC 10 through the communication section 214 and the PC 10 stores the received image data”, “Scan-to-PC (the multifunction machine 20 transmits the image data scanned by the reading section 204 to the PC 10 through the communication section 214 and the PC stores the received image data)”, “Scan-to-media (the image data scanned by the reading section 204 are stored in the removable media 2101 through a media interface (hereinafter, referred to as “media IF”) section 210)”, “Scan-to-mail (the image data scanned by the reading section 204 are transmitted through the communication section 214)”, “Fax reception (the image data received by the line communication section 212 are printed by the recording section 202)”, “Copy (the image data read by the reading section 204 are printed by the recording section 202)”, “Telephone transmission”, “Telephone reception”, and “Media print (the image data or the document data stored in the removable media 2101 are printed by the recording section 202) are defined respectively.

The paper file ID used as the destination address serves to identify the paper files 42 and 46 or the printed materials 44 and 48 and are given as barcodes to the paper files 42 and 46 or the printed materials 44 and 48. The address stored as the target document address is set to an address in the storage section 108 storing the document data constituting the documents or printed materials 44 and 48 filed in the paper files 42 and 46.

“GID (Group ID)” defined in FIG. 3 is an individual ID given to respective groups into which the respective processing operations (statuses) are divided. Specifically, GID “2” is given to the processing operation of which the destination address is stored, but “0” and “1” are given to the processing operations of which the destination address is set to “None.” GID “1” is given to a processing operation (only “PC print” in the illustrative aspect) using target document data previously stored in the storage section 108, and GID “0” is given to a processing operation of which target document data are stored by performing the processing operation.

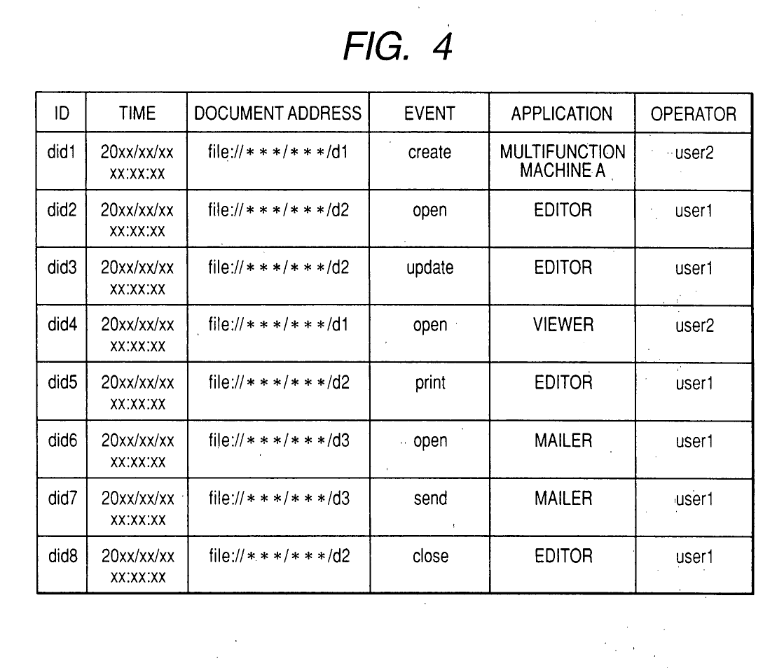

The document table 1083 stores a work or instruction performed to a document. Here, as shown in FIG. 4, an ID is given to a time when the work or the like is performed (wherein it can be properly determined what time the work or the like is performed), information indicating a location of the document, a work or the like (event) performed to the document, a device performing the work or the like (operating application), and a user carrying out the work.

Data treated in the document table 1083 comprise the document data, image data, and sound data.

Here, as a work (event) performed to a document, “create”, “open”, “update”, “print”, “send”, and “close” are defined. More specifically describing the events, when a new document is prepared, for example, when a document is prepared by a manipulation of the operation section 104 of the PC 10, when a document is scanned or copied by the use of the reading section 204 of the multifunction machine 20, the document is received in fax or in PC fax by the use of the line communication section 212, or when a communication sound is stored through telephone transmission or telephone reception using the line communication section 212, “create” is stored as an event in the document table 1083.

When the document data, the image data, or the sound data stored in the storage section 108 of the PC are opened by the use of the operation section 104 and when an HP is opened by the use of the operation section 104, “open” is stored as an event in the document table 1083. When the document data or the like are closed, “close” is stored.

When the document data, the image data, or the sound data previously stored in the storage section 108 are updated by an editor stored in the PC 10, “update” is stored as an event in the document table 1083.

When the document data or the image data previously stored in the storage section 108 are printed by the editor, “print” is stored as an event in the document table 1083.

When the document data, the image data, or the sound data previously stored in the storage section 108 are transmitted by a mail transmitting and receiving application stored in the PC 10, or when the document data or the image data previously stored in the storage section 108 are transmitted through the PC fax transmission or the fax transmission of the multifunction machine 20, “send” is stored as an event in the document table 1083.

In the document table 1083, one of the above-mentioned items is stored as a record every time when a work is performed to a document, like in the status table 1081.

Here, the status table 1081 and the document table 1083 need not be two tables different from each other, but may be one table if only the items constituting the records of the tables can be specified.

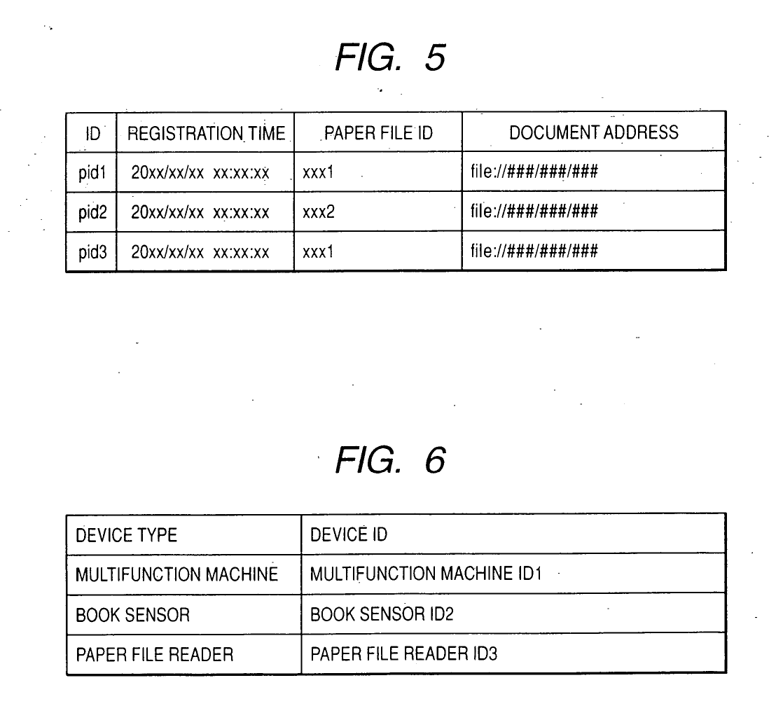

As shown in FIG. 5, a unique ID for identifying a record, a time when the record is written, a paper file ID for identifying the paper files 42 and 46, and a document address for specifying the printed materials 44 and 48 filed in the paper files 42 and 46 are stored as a record in the file information table 1085.

The paper file ID serves to identify the paper files 42 and 46 and is written in barcodes 442 and 462. The document address stored as the target document address serves to correlate the paper files 42 and 46 with the printed materials 44 and 48 filed the rein and denotes an address of an electronic document resulting in the printed materials 44 and 48. That is, when the electronic document resulting in the printed materials 44 and 48 is stored in the storage section 108 of the PC 10, the address in the storage section 108 storing the electronic document is stored as the document address, or when the electronic document is an HP, the address of the HP is stored as the document address. The information is written to the barcodes 442 and 448 recorded in the printed materials 44 and 46.

When a plurality of multifunction machines 20, the book sensor 30, and the paper file reading section are connected to the network line 50, the device designating table 1087 is a table, which specifies and stores a target of the information management system 1 among the multifunction machines 20 and the like. The device designating table comprises the structure shown in FIG. 6.

(Process 1 of Information Management System)

Next, process (1) of the information management system illustrated as above will be described with reference to the figures.

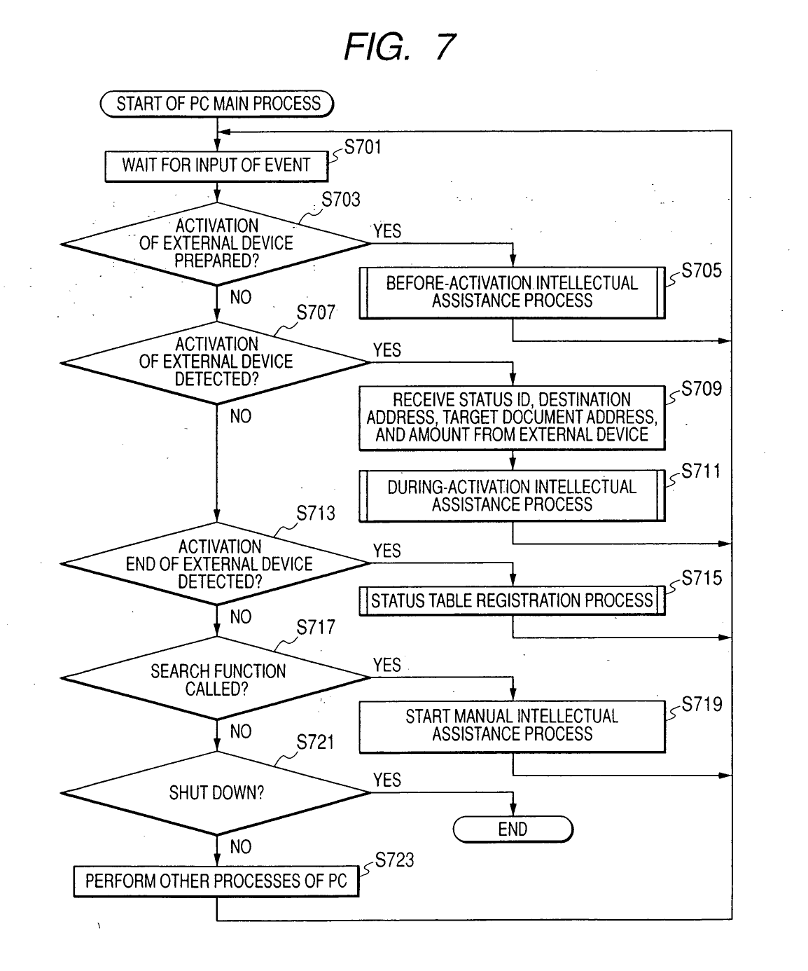

FIG. 7 is a diagram illustrating a flow of a main process performed by the PC 10. The process shown in the flow is performed by the control section 100 of the PC 10, and more specifically, the CPU of the control section 10 performs the process by the use of a program stored in the ROM or the like.

First, the control section 100 waits until an instruction for performing any one process is input through the operation section 104 of the PC 10 or the communication section 102 from a designated external device shown in FIG. 6, such as the multifunction machine 20, the book sensor 30, and the paper file reading section 40 (step 701).

Thereafter, when it is detected in step 701 that an instruction is given, the process is specified. That is, when an instruction is input to the control section 100 first determines whether the instruction is an instruction for activating a printer driver controlling the recording section 202 of the multifunction machine 20 or an instruction for preparing for activation of the external device such as activation of a multifunction machine utility for using the reading section 204 of the multifunction machine 20 (step 703).

When it is determined in step 703 that the input instruction is to prepare for the activation of the external device (step 703: YES), the control section 100 of the PC 10 performs a before-activation intellectual assistance process to be described later and waits until an instruction for performing a process is input (step 701).

The before-activation intellectual assistance process means a process of alarming a user having given the instruction so as to prevent the redundant printing when an instruction for printing the specified document data is given to the recording section 202 of the multifunction machine 20 from the PC 10 but the process of printing the document is previously performed within a predetermined time. The before-activation intellectual assistance process comprises a process of alarming a user having given a fax transmission instruction so as to prevent the redundant fax transmission when the fax transmission instruction for transmitting specific document data to a specific counter party is given to the line communication section 212 of the multifunction machine 20 from the PC 10 but the document data are previously transmitted to the counter party.

On the other hand, when the input instruction is not to prepare for the activation of the external device (step 703: NO), it is determined whether the instruction detected in step 701 is an instruction from one of the multifunction machine 20, the book sensor 30, and the paper file reading section 40 designated in FIG. 6 and an instruction for detecting the activation of the external device (step 707).

When it is determined in step 707 that the instruction is an instruction for detecting the activation of the external device (step 707: YES), the control section 100 receives the information defined in FIG. 3, that is, the status ID, the destination address, the target document address, and the amount, from the external device (step 709). The status ID and the like are stored in the RAM of the control section 100.

Then, the control section performs a during-activation intellectual assistance process (step 711) and then waits until an instruction for performing another process is input when the process is finished (step 701).

The during-activation intellectual assistance process means a process for providing the information used until that time as information associated with a present work when a process corresponding to the same instruction as the instruction from the external device was performed in the past.

When the input instruction is not to prepare for the activation of the external device (step 707: NO), it is determined whether the instruction detected in step 701 is to detect the end of the detected activation of the external device (step 713).

When it is determined in step 707 that the instruction is to detect the end of the activation of the external device (step 713: YES), the control section 100 performs a status-table registration process to be described later (step 715) and the n waits until an instruction for performing another process is input when the status-table registration process is finished (step 701).

When the input instruction is not to end the activation of the external device (step 713: NO), it is determined whether the instruction detected in step 701 is to call a search function (step 717).

When it is determined in step 717 that the input instruction is to call a search function (step 717: YES), the control section performs a manual intellectual assistance process to be described later (step 719) and then waits until an instruction for performing another process is input when the manual intellectual assistance process is finished (step S701).

The manual intellectual assistance process is to provide a user with information associated with a user' present work in response to a condition designated by the user.

When the input instruction is not the manual intellectual assistance process (step 717: NO), it is determined whether the instruction detected in step 701 is to shut down the PC 10 (step 721). When the instruction is to shut down the PC 10 (step 721: YES), the PC 10 is shut off. When the instruction is not to shut down the PC (step 721: NO), a process corresponding to the instruction is performed (step 723). After performing the process, the control section waits until an instruction for performing another process is input (step 701).

(Before-Activation Intellectual Assistance Process)

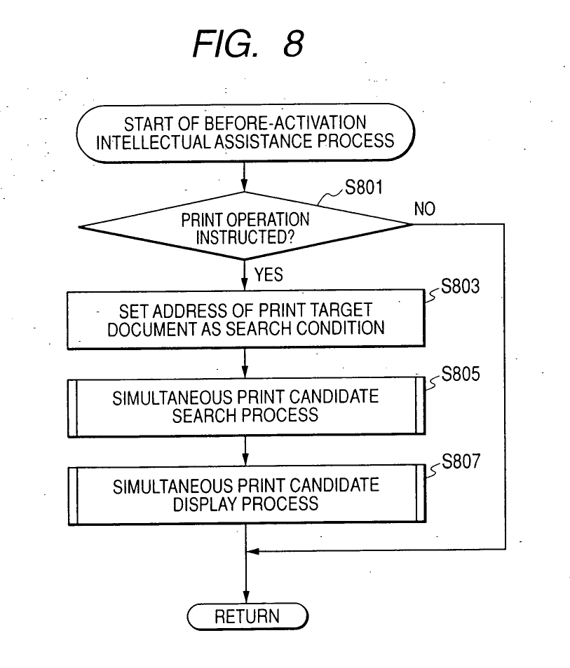

FIG. 8 is a diagram illustrating a flow of a before-activation intellectual assistance process.

When the before-activation intellectual assistance process is performed in step 705, it is first determined whether the input instruction for preparing for the activation of the external device is a printing instruction to the recording section 202 (step 801). When the input instruction is the printing instruction (step 801: YES), step 803 is performed.

On the other hand, when the input instruction is not the printing instruction (step 801: NO), the controller ends the before-activation intellectual assistance process and waits again in step 701 until an instruction for performing another process is input.

When a document as a target of the printing instruction in step 803 was utilized in the past, the document is correlated with a print target document on the basis that the document was opened at the same time as another document. Accordingly, an address of the print target document data is set as a search condition and a simultaneous candidate search process is performed on the basis of the search condition (step 805).

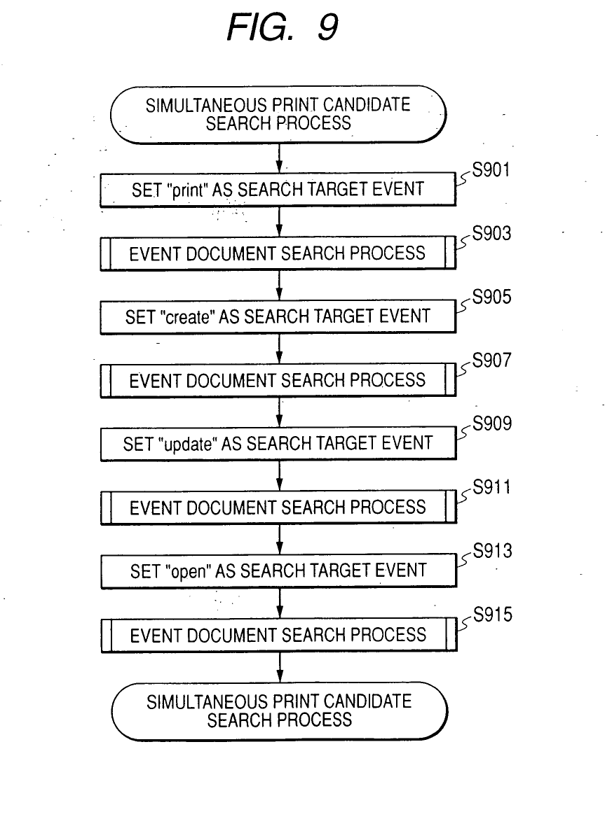

FIG. 9 is a diagram illustrating a flow of a simultaneous print candidate search process. When the print target document data was utilized in the past, a printed document, that is, a record of which the event is “print”, a newly created document, that is, a record of which the event is “create”, an updated and stored document, that is, a record of which the event is “update”, and an opened document, that is, a record of which the event is “open” are searched out from the document table shown in FIG. 4.

First, “print” is set as the event as a search target event (step 901) and an event document search process (step 903) is performed.

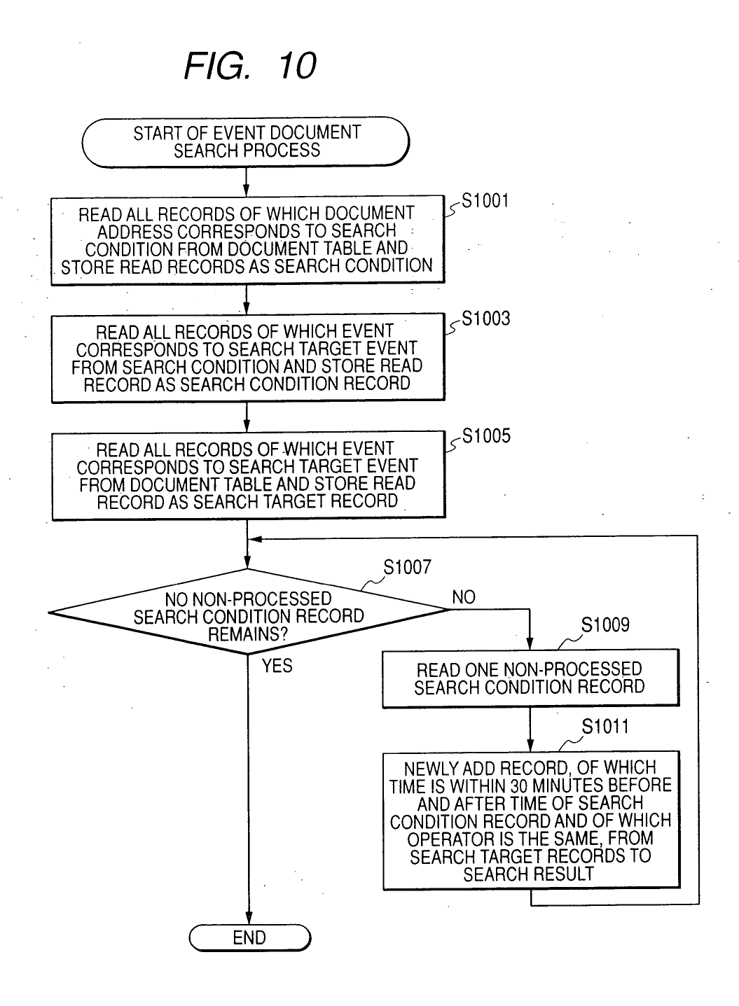

FIG. 10 is a diagram illustrating a flow of an event document search process. First, at the time of starting the process, all the records having the address of the print target document data of which the document data address is the search condition set in step 803 are read from the document database 1083 and are stored as search condition records (step 1001).

Next, all the records of which the event is the search target event previously set (in this case, “print” set in step 901) are read from the search condition records and are newly stored as the search condition records (step 1003) and then the process of step 1005 is performed.

In step 1005, all the records of which the event is the search target event previously set (in this case, “print” set in step 901) are read from the document database 1083 and are stored as the search condition records.

Then, it is determined whether a process to be described later has been performed to all the search condition records, that is, whether any non-processed search condition record remains. Here, when it is determined that no non-processed record remains, that is, that all the search condition records have been processed (step 1007: YES), the event document search process is ended.

On the other hand, when it is determined that a non-processed search condition record remains (step 1007: NO), one non-processed search condition record is read out in step 1009. The record of which the time is within 30 minutes before and after the time of the read search condition record and of which the operator is the same is stored as a search result in the search target records in step 1011.

The same operator is set as a search condition in the first illustrative aspect of the invention (step 1011), but when document data utilized in common by another operator exist in the PC connected to the network, it is preferable that the condition of the same operator is not necessary.

The processes of step 1009 and 1011 are repeatedly performed until all the search condition records have been processed.

As described above, in steps 901 and 903, another document data which was printed within 30 minutes before and after the target document data was printed in the past can be searched out as being correlated with the print target document data.

When the event document search process (step 903) is ended, “create” is set as a new search target event (step 905) and the event document search process (step 907) is performed similarly to the process of step 903.

Accordingly, another document data (having the event “create”) which was newly created within 30 minutes before and after the print target document data was newly created in the past can be searched out as being correlated with the print target document data.

When the event document search process (step 907) is ended, “update” is set as a new search target event (step 909) and the event document search process (step 911) is performed similarly to the process of step 903.

Accordingly, another document data (having the event “update”) which was updated and stored within 30 minutes before and after the print target document data was updated and stored in the past can be searched out as being correlated with the print target document data.

When the event document search process (step 911) is ended, “open” is set as a new search target event (step 913) and the event document search process (step 915) is performed similarly to the process of step 903.

Accordingly, another document data (having the event “open”) which was opened within 30 minutes before and after the print target document data was opened in the past can be searched out as being correlated with the print target document data.

The period of time added to the time of the search condition record is not limited to 30 minutes before and after, but may be 10 minutes before and after and 60 minutes before and after, or a predetermined period of time may retroact or may be added only before or only after the time.

The added time may be set to any time by a user or may be set in advance in a program for the event document search process.

In the simultaneous print candidate search process (step 805) according to the first illustrative aspect, “print”, “create”, “update”, and “open” are set as the search target events, and this is because the search target as the correlated document data is the document data which was printed, newly created, updated, or opened in the period in which the print target document data was utilized in the past. In addition, “send” and “close” may be properly added to the events. In this case, the search target as the correlated document data can include the document data which was transmitted in an electronic mail or the document data which was closed, which can be considered as being correlated.

In other words, by excluding an event, to which it is not intended to give a correlation, from the steps of the simultaneous print candidate search process, it is possible to use as the search target the document data specified by desired events and to provide the correlated document data corresponding to the desire of the user.

By setting the period of time added to the time of the search condition record to a narrower period of time, the narrower period of time before and after the print target document data was processed in the past can be used as a search target. Accordingly, only the records having a higher degree of correlation can be searched out and extracted.

By performing the simultaneous print candidate search process (step 805), it is possible to search out another document data having been subjected to the same processing operation as the processing operation which was performed to the print target document data in the past and to search out the document data having a degree of correlation higher than that of the document data simply utilized in the same period.

Subsequently, a simultaneous print candidate display process (step 807) of displaying the document data specified on the basis of the search result of the simultaneous print candidate search process (step 805) as candidates to be simultaneously printed as being correlated with the print target document data is performed.

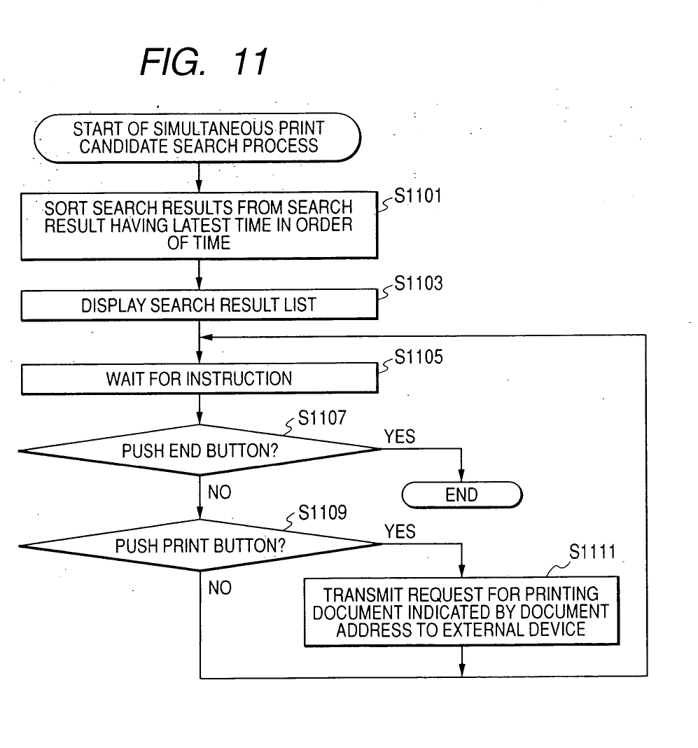

FIG. 11 is a diagram illustrating a flow of the simultaneous print candidate display process.

First, the search result records extracted in the simultaneous print candidate search process (step 805) are sorted from the record having the earliest time (step 1101) and the result is displayed on the display unit 106 of the PC 10 as a search result list shown in the figure (step 1103). Then, the controller waits in step 1105 until another operation is performed by the user.

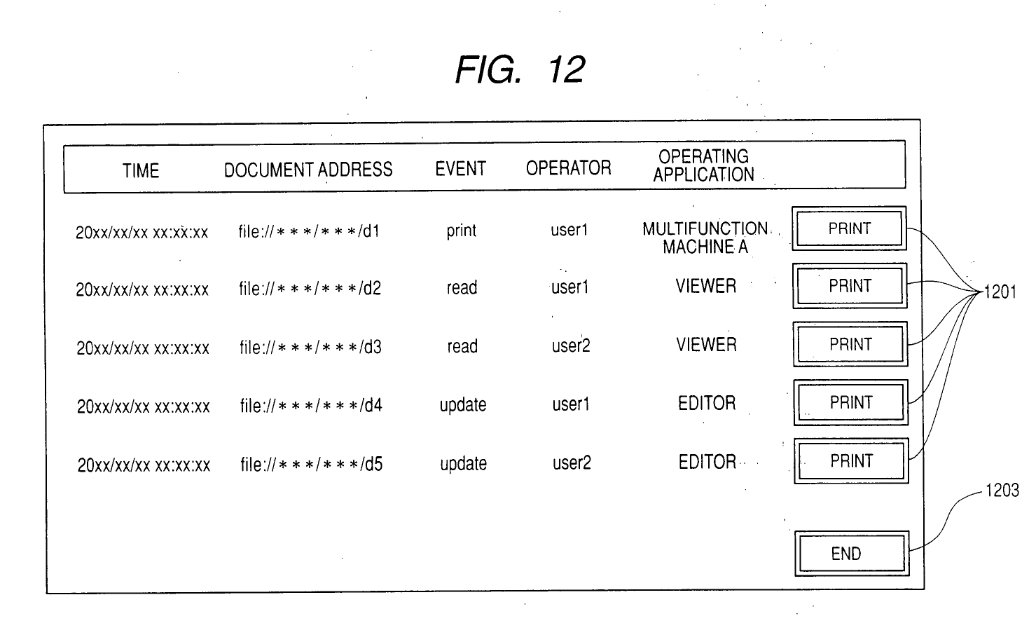

The items of the document table 1083, such as times, document addresses, events, operators, and operating applications, are displayed in the search result list shown in FIG. 12.

In the search result list, by pushing the print button 1201 by the use of the manipulation unit 104 of the PC 10, the document data specified by the target document address of the record corresponding to the pressed print button 1201 is printed by the writer 202 of the multifunction machine 20. By pushing the end button 1203, the search result list can be closed.

Here, when the end button 1203 is pushed (step 1107: YES), the simultaneous print candidate display process is ended and the controller waits again in step 701 until an instruction for performing another process is input.

On the other hand, when it is determined that the end button 1203 is not pushed (step 1107: NO) and the print button 1201 is not pushed (step 1109: NO), the controller waits again in step 1105 until any button is pushed.

When it is determined that the end button 1203 is not pushed (step 1107: NO) and the print button 1201 is pushed (step 1109: YES), a print request for printing the document data specified by the document address of the record corresponding to the pushed print button 1201 is transmitted to the multifunction machine 20 (step 1111) and the controller waits again in step 1105 until another operation is performed.

As described above, by adding the above-mentioned process to the before-activation intellectual assistance process, it is possible to provide a user with a document correlated with a print target document right when an instruction for preparing for the activation of an external device is input and to easily provide the user with the correlated document in a print-practicable manner.

In the first illustrative aspect, the correlated and searched result is output to the display unit 106 of the PC 10, but may be output to the display unit 218 of the multifunction machine 10.

All the searched-out documents may be output without displaying the search result list, only a part of the searched-out documents may be output. These can be properly set in accordance with the environment in which the system is activated.

In the first illustrative aspect, the correlated data are exemplified as the document data. However, the correlated data are not limited to the document data, but may be music data or image data. In this case, the data may be output from the sound output unit 208 or the display unit 218 of the multifunction machine 20 or the sound output unit such as a speaker or the display unit 106 of the PC 10.

(During-Activation Intellectual Assistance Process)

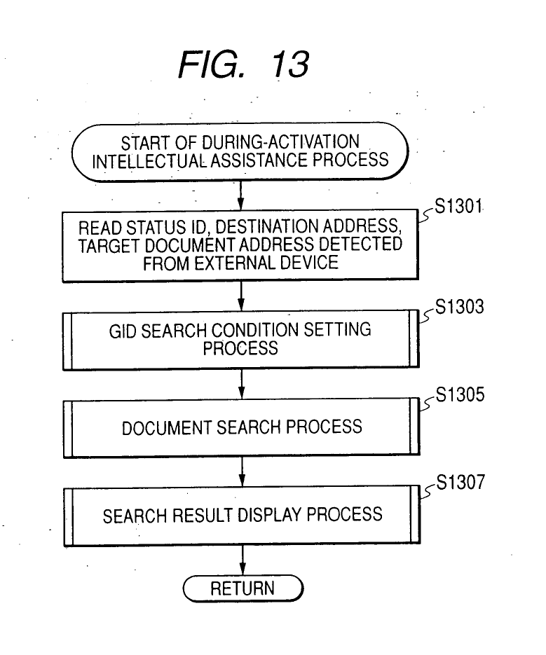

FIG. 13 is a diagram illustrating a flow of a during-activation intellectual assistance process.

In step 711, when the during-activation intellectual assistance process is performed, the control section 100 of the PC 10 first reads the status ID, the destination address, and the target document address input (detected) from the external device in step 709 (step 1301) and performs a GID search condition setting process (step 1303).

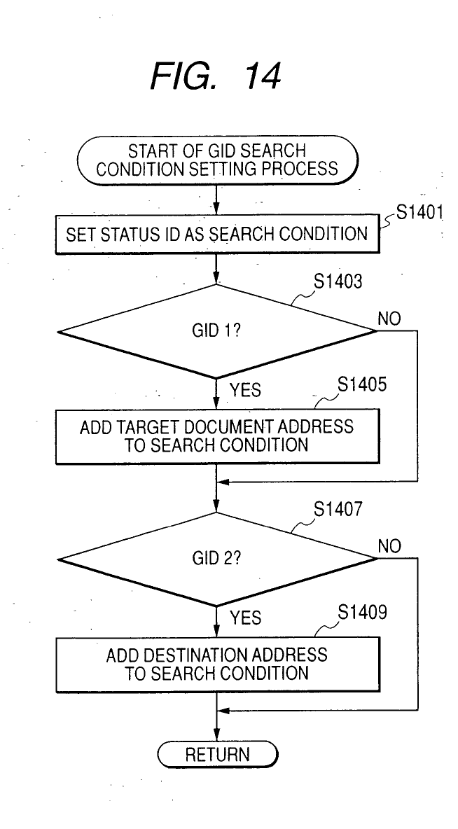

FIG. 14 is a diagram illustrating a flow of a GID search condition setting process. First, the status ID (see FIGS. 2 and 3) is set as the search condition (step 1401). Next, in order to specify a search condition for performing the search in a so-called “AND condition” with the status ID set in step 1401 when the document search process of step 1305 is performed, the format of a GID is determined to extract a search condition specific to the respective processing operations. That is, it is first determined whether the GID of the status ID set in step 1401 is “1” (see FIG. 3) (step 1403).

When it is determined in step 1403 that the GID is “1” (step 1403: YES), the target document address is added as the search condition (step 1405) and the process of step 1407 is performed. When it is determined in step 1403 that the GID is not “1”, the process of step 1405 is not performed, but the process of step 1407 is performed.

In step 1407, it is determined whether the GID of the status ID set in step 1401 is “2” (see FIG. 3) (step 1407).

When it is determined in step 1407 that the GID is “2” (step 1407: YES), the destination address is added as the search condition (step. 1409). The GID search condition setting process is finished and then the document search process (step 1305) is performed using the search conditions specified through the GID search condition setting process.

On the other hand, when it is determined in step 1407 that the GID is not “2”, the GID search condition setting process is finished. Then, the document search process (step 1305) is performed using the search conditions specified through the GID search condition setting process.

When “NO” is determined in steps 1403 and 1407, it is the case in which the GID corresponding to the status ID is “0.”

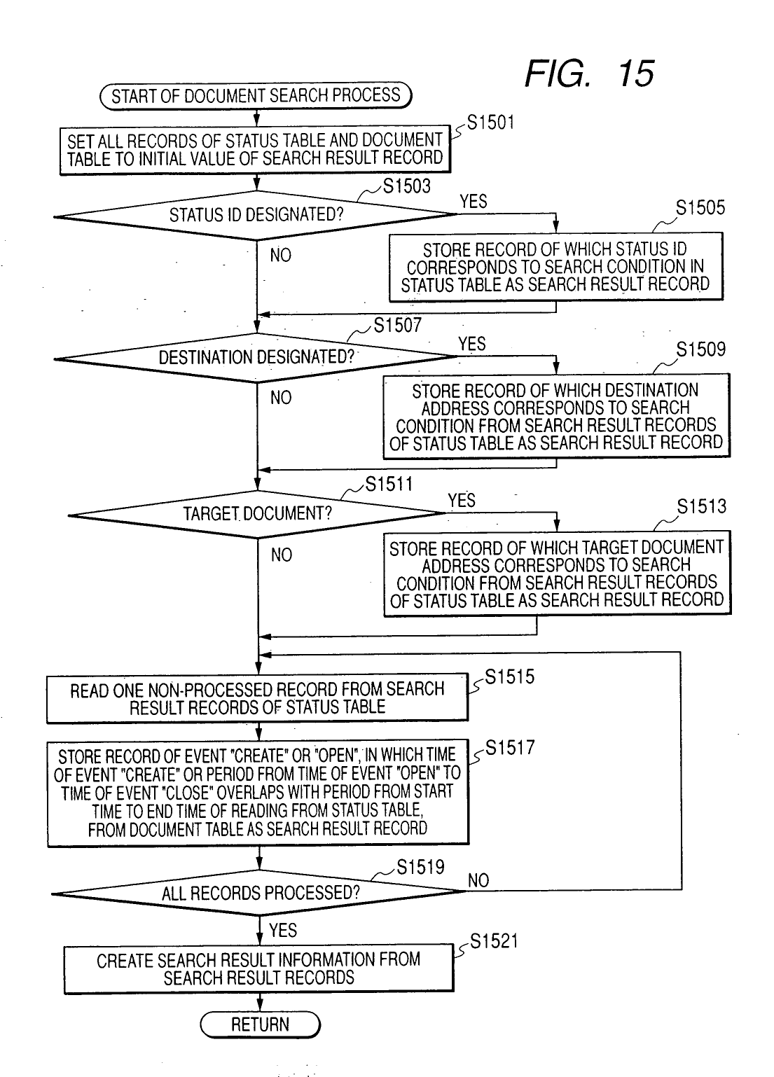

FIG. 15 is a diagram illustrating a flow of the document search process (step 1305). First, all the records of the status table 1081 and the document table 1083 are set to the initial value of a search result record (step 1501).

Next, in order to specify a target document associated with a specific record from the status table 1081, a search process is performed with the search conditions set in the GID search condition setting process (step 1303) previously performed.

That is, first, it is determined in step 1503 whether the status ID is designated as the search condition. In the during-activation intellectual assistance process (step 711), the status ID is generally set as the search condition in step 1401. Accordingly, the determination of step 1503 is “YES”, a record corresponding to the status ID set as the search condition from the status table 1081 is stored as a new search result record (step 1505), and then the process of step 1507 is performed.

In step 1507, it is determined whether the destination address is set as the search condition, that is, whether the determination of step 1407 is “YES” and the destination address is added as the search condition in step 1409. When it is determined that the destination address is set (step 1507: YES), a record corresponding to the destination address designated as the search condition from the search result records stored in step 1505 is stored as anew search result record (step 1509), and then the process of step 1511 is performed. When it is determined in step 1507 that the destination address is not set as the search condition (step 1507: NO), the process of step 1509 is not performed, but the process of step 1511 is performed.

It is determined in step 1511 whether the target document address is set as the search condition, that is, whether the determination of step 1403 is “YES” and the target document address is set as the search condition in step 1405. When it is determined that the target document address is set (step 1511: YES), a record corresponding to the target document address designated as the search condition from the search result records stored in step 1505 is stored as a new search result record (step 1513), and then the process of step 1515 is performed. When it is determined in step 1511 that the target document address is not set as the search condition (step 1511: NO), the process of step 1513 is not performed, but the process of step 1515 is performed.

In steps 1509 and 1513, a new search result record corresponding to the respective search conditions is stored on the basis of the search result record specified in step 1505. This is because only one GID corresponding to the respective status ID is set (see FIG. 3).

Instep 1515, in order to perform the processes subsequent to the process of step 1517, one non-processed search result record (substantially one record in the status table 1081) is read from the search result records specified in steps 1503 to 1513 and the process of step 1517 is performed.

In step 1517, in the records stored in the document table 1083 and set to the initial value of the search result record in step 1301, when a period from the time registered in the record comprising the event “create” or “open” to the time registered in the record comprising the event “close” and the same document address as the document address of the record comprising the event “create” (that is, a period when it can be determined that the same document is “opened” or “treated” by the PC 10) overlaps with the period from the start time to the end time of the record read from the status table 1081 in step 1515, the record to be processed in the document table 1083 is stored as the search result record (step 1517).

That is, in the process (step 1517), the document, which, it is determined, opened or treated at the same time as the external device suitable for the instructed search condition is extracted.

In the information management system 1 according to the first illustrative aspect, when it is intended to utilize again the data having been utilized at that time by using a user's behavior as a key, the document data having been utilized in the same period as the processing operation of the multifunction machine 20 or the like connected to the PC 10 can be considered as being correlated with the processing operation by using the processing operation as the information indirectly indicating the user's behavior. As a result, the document data having been utilized in the same period as the target document (address) as the target of the processing operation can be considered as being correlated with each other. Accordingly, the records having the event “create” or “open” of which the processing times overlap with each other are stored as the search result records.

When the period from the time registered in the record comprising the event “create” or “open” to the time registered in the record comprising the event “close” and comprising the same document address as the document address of the record comprising the event “create” is determined, the identity of the user (operator in FIG. 4) is considered.

In step 1517, it is determined whether the process of step 1519 is performed to all the records stored as the search result records in the status table 1081. When it is determined that the process is performed to all the records (step 1519: YES), search result information is prepared from the search result record based on the above-mentioned process (step 1521), and then the document search process (step 1305) ends. When it is determined that the process is not performed to all the records (step 1519: NO), the processes repeat from step 1515.

In the information management system 1 according to the illustrative aspect, since the records stored in the status table 1081 are stored as records in the document table at the time of performing the processing operation (see “Document Table Updating Process” to be described later), the records in both tables satisfy the search conditions in step 1517 and are stored as the search result records.

Accordingly, since the search result records stored based on the records stored through the same process is excluded, the start time or the end time of the search result record specified from the status table 1081 is preferably equal to the time of the document table 1083. In addition, even when the condition of step 1517 is satisfied, the search result records in which the target document address and the document address are identical are preferably not stored in step 1517.

When the document search process (step 1305) is finished, the control section 100 performs a process of displaying the search result based on the document search process (step 1305) (step 1307).

In the document search process of step 1517, the determination using the overlapping of two periods has been performed. However, when the time registered in the record comprising the event “create”, “open”, or “close” is comprised in the period from the start time to the end time of the records in the status table 1081, both periods necessarily overlap with each other. Accordingly, except for the case in which the period from the start time to the end time of the record in the status table 1081 is all comprised in the period from the time registered in the record comprising the event “create” or “open” to the time registered in the record comprising the event “close” and comprising the same document address as the document address of the record comprising the event “create” or the like, it is preferable in view of rapid determination to employ this simple determination along with the determination of step 1517.

Similarly, when one of the start time and the end time of the record of the status table 1081 is comprised in the period from the start time of the record comprising the event “create” or “open” to the time registered in the record comprising the event “close” and comprising the same document address as the document address of the record comprising the event “create” or the like, both periods necessarily overlap with each other. Accordingly, as described above, it is preferable in view of rapid determination to employ this simple determination along with the determination of step 1517.

When the time registered in the record comprising the event “create”, “open”, or “close” overlaps with one of the start time or the end time of the record in the status table 1081, both periods necessarily overlap with each other. Accordingly, as described above, it is preferable in view of rapid determination to employ this simple determination along with the determination of step 1517.

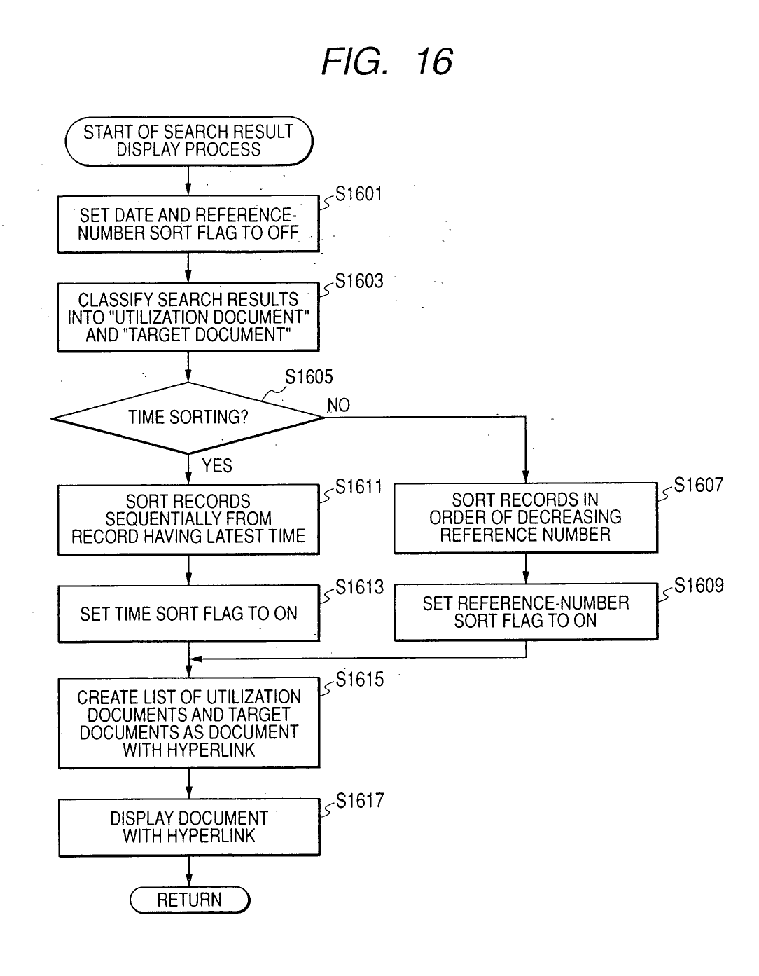

FIG. 16 is a diagram illustrating a flow of a search result display process (step 1307). First, at the time of starting the process, the date and the reference sort flag are set to OFF (step 1601).

Next, the search result records specified as the search result information prepared in step 1521 are classified into search result records specified from the status table 1081 (specified through steps 1503 to 1513) and search result records specified from the document table 1083 (specified through steps 1515 to 1517). The former is a search result associated with a target document and the latter is a search result associated with a utilization document. The search result records are classified into both search results (step 1603).

When the process of step 1603 is finished and then the search result information for classification into the utilization documents and the target documents in step 1603 is displayed, a process of determining in what order the utilization documents and the target documents are displayed is performed.

First, it is determined in step 1605 whether a time sorting method is selected for the display order (step 1605).

When the reference-number sorting method is selected, that is, when the time sorting method is not selected (step 1605: NO), the search result records having been classified into the utilization documents and the target documents in step 1603 are sequentially sorted from the search result record having the largest reference number in the order of decreasing the reference number (step 1611), and then the time sort flag is set to ON (step 1613). Thereafter, the process of step 1615 is performed.

On the other hand, when the time sorting method is selected (step 1605: YES), the control section 100 sequentially sorts the search results from the search result record comprising the latest time on the basis of both search results and the target documents in step 1603 (step 1611), and then the time sort flag is set to ON (step 1613). Thereafter, the process of step 1615 is performed as described above.

In the information management system according to the illustrative aspect, the search results can be sorted using two items of time and reference number at the time of displaying the search results. Accordingly, it can be determined as follows in which of the m the search results are sorted. That is, by determining whether the search results are sorted in one item, specifically, by determining whether the time sorting method is selected, it can be determined by the use of which of the time and the reference number a user intends to sort the search results (when the time sorting method is not selected, it is considered that the reference number sorting method is selected).

When the search results are sorted in the order of the time or the reference number, which is used to sort the search results may be selected by the user through the operation section 104, for example, after performing the process of step 1601 and before performing the process of step 1605.

In step 1615, lists of the utilization documents and the target documents are prepared so as to access the documents on the basis of the search result records sorted in accordance with the condition selected in step 1607 or 1611. The lists are displayed in step 1617.

In the information management system 1 according to the first illustrative aspect, when the activation of the external device is detected in step 707, the during-activation intellectual assistance process (step 711) is performed in response to the detection. Accordingly, since the documents, which are considered as being opened or treated at the same time in the past can be notified to the user with the detecting operation. As a result, when a process is necessary for the documents associated with this process, the necessary process can be performed at the same time.

For example, in case of fax transmission, it is possible to determine whether the documents opened at the time of the previous fax transmission should be transmitted by opening the documents.

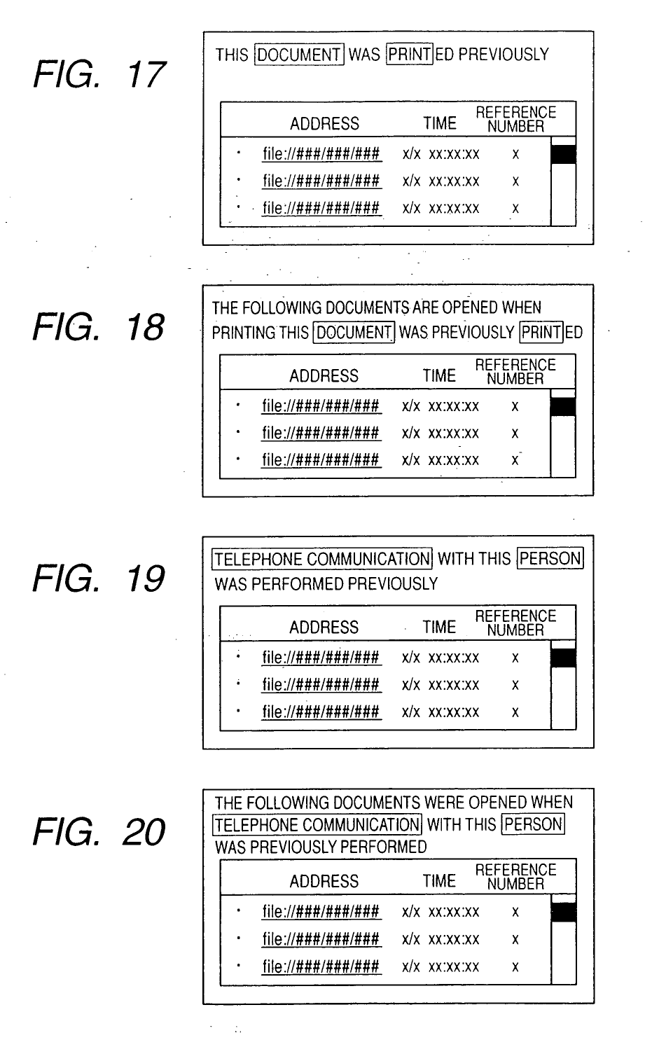

FIGS. 17 to 20 are diagrams illustrating the process results of the during-activation intellectual assistance process displayed on the display section 106 of the PC 10 by performing step 1617.

Specifically, FIG. 17 shows a search result associated with the target document specified by performing the during-activation intellectual assistance process (step 711) when an instruction of printing documents data stored in the storage section 108 is given to the recording section 202 of the multifunctional machine 20 from the PC 10 (a PC print operation is performed as the processing operation: see FIG. 3).

That is, when the PC print operation is performed, the document search process (step 1305) is performed on the basis of the target document address as a processing target of the PC print operation. As a result, the time when the target document data as a print target of the print operation were printed is displayed in the format shown in FIG. 17. In this case, the addresses and the reference numbers in FIG. 17 are displayed to be identical.

FIG. 18 shows a utilization document opened in the period in which the target document data as the present print target was being printed.

For example, when the ID in FIG. 2 is “sid1” (the start time of the record is “11:59:00 on Jul. 15, 2005” and the end time is “12:02:00 on Jul. 15, 2005”) and the document addresses of the utilization documents associated with the target document of sid1 are “file://***/***/d2” and “file://***/***/d3” (in FIG. 4, the time registered in the ID utilizing the document address of the utilization document is “11:50:00 on Jul. 15, 2005” for did2, “12:00:00 on Jul. 15, 2005” for did6, and “12:01:00 on Jul. 15, 2005” for did8), the documents associated with “file://***/***/d2” and “file://***/***/d3” are opened in the period when the PC print operation associated with sid1 was being performed. Accordingly, predetermined details associated with the two utilization documents are displayed in the format shown in FIG. 18.

FIGS. 19 and 20 show display examples when the communication results from the telephone transmission (event “TLT” in FIG. 3) or the telephone reception (event “TLR” in FIG. 3) through the line communication section 212 of the multifunction machine 20 in step 707) (the course to the display is the same as described above and thus is omitted).

In FIG. 17, since the processing operation is a PC print operation, the GID is “1” (see FIG. 3), and the document search process (step 1105) is performed using the document address as the search condition, the addresses and the reference numbers are identical and only the times are different from each other. However, in case of the telephone transmission or the telephone reception, the GID is “2” (see FIG. 3) and the document search process (step 1105) is performed without using the document address as the search condition. Accordingly, the target document addresses shown in “Address” of FIG. 19 are different from each other.

In the information management system 1 according to the first illustrative aspect, the addresses in FIGS. 17 to 20 are displayed in the hyperlink format (step 1417), and when the hyperlinks are selected using the operation section 104, the document data associated with the address are read from the storage section 108 and are displayed on the display section 106.

(Status Table Registering Process)

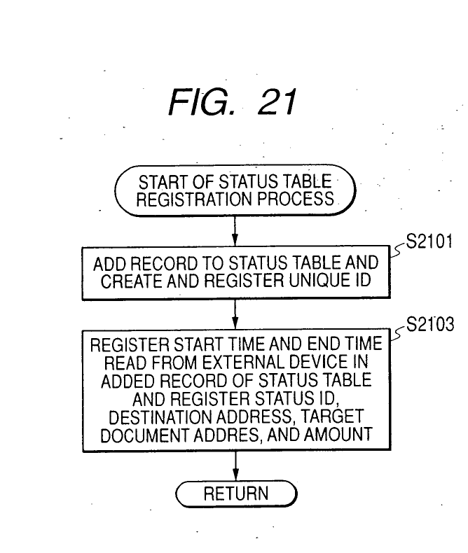

FIG. 21 is a diagram illustrating a flow of a registering process in the status table 1081 shown in FIG. 2.

When the status table registering process is performed in step 715, the control section 100 of the PC 10 additionally creates a unique ID of a record to be registered in the status table 1081. Then, the control section registers the unique ID as an ID of the new record (step 2101) and then performs the process of step 2103.

In step 2103, the time when the activation of the external device is detected in step 707 and the time when the activation end of the external device of which the activation has been detected in step 707 is detected in step 713 are registered as the start time and the end time of the new record in step 2101, respectively, and the status ID, the destination address, the target document address, and the amount, which are input from the external device of which the activation has been detected and stored in the RAM or the like of the control section 100 in step 709 before the during-activation intellectual assistance process (step 711), are similarly registered in the new record in step 2101.

(Manual Intellectual Assistance Process)

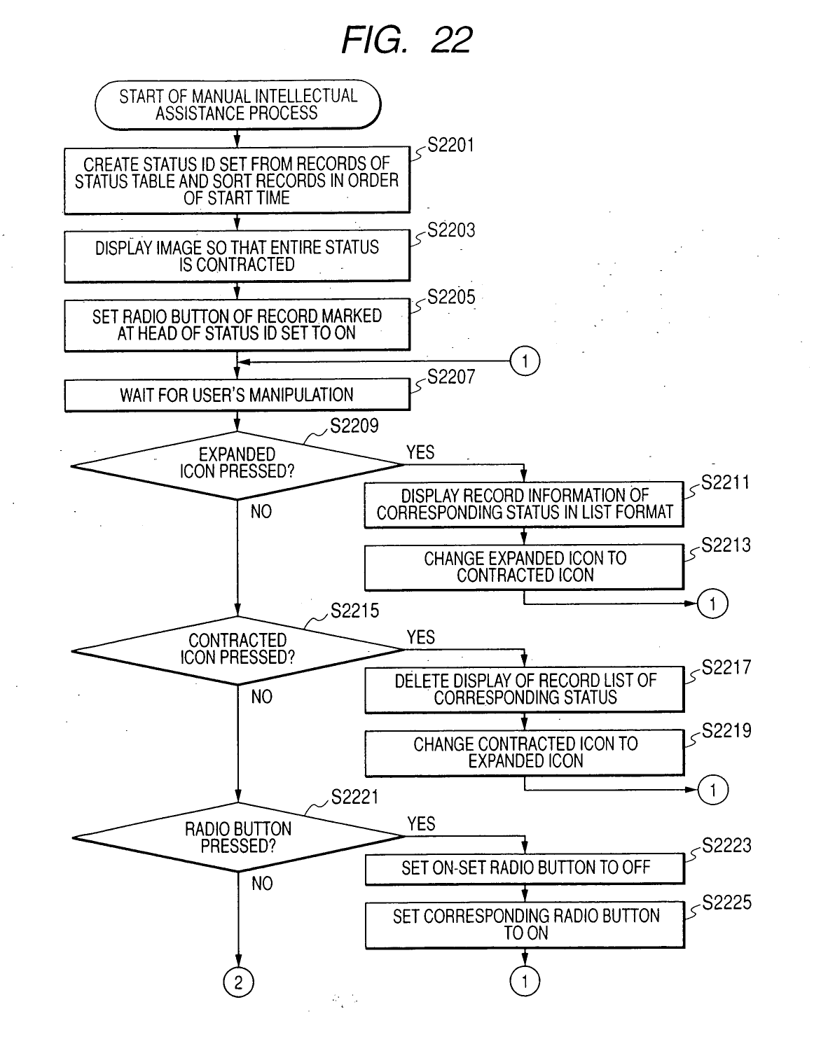

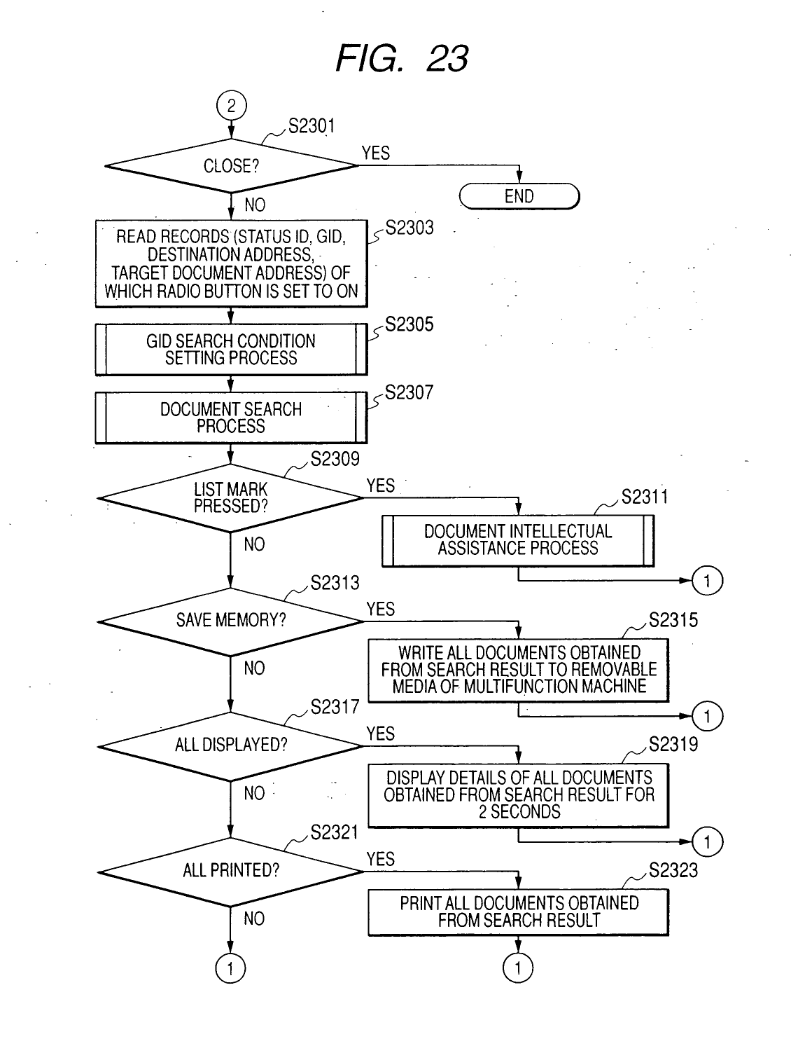

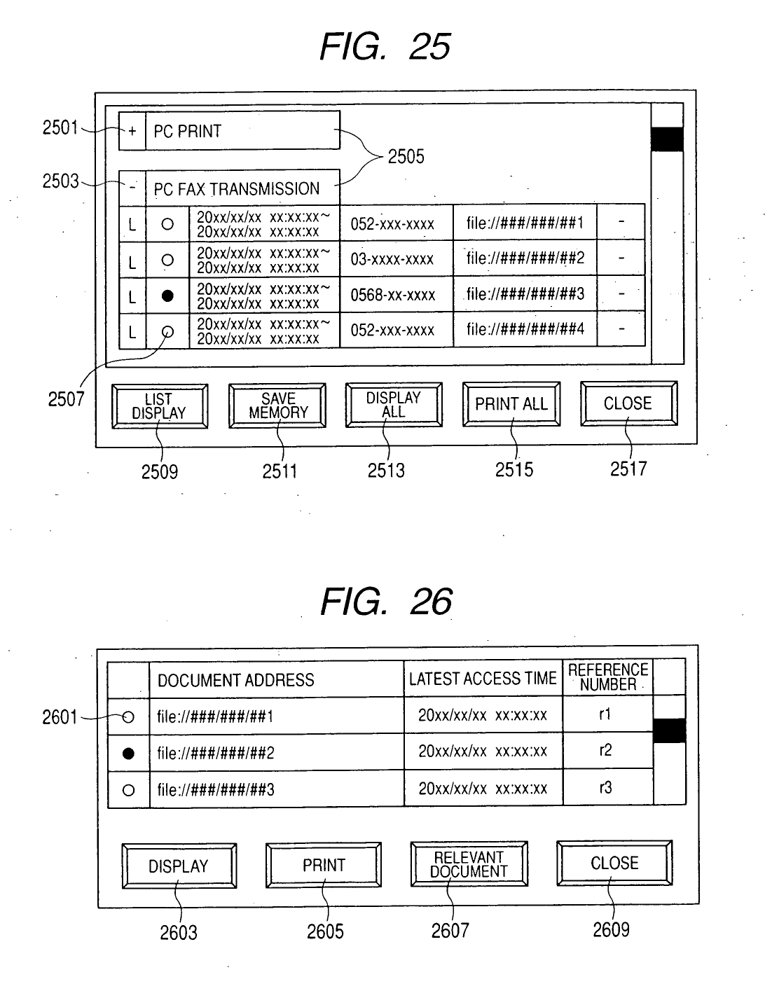

FIGS. 22 and 23 are diagrams illustrating a flow of the manual intellectual assistance process. FIG. 25 is a diagram illustrating a display format of information displayed on the display section 106 of the PC with the performing of the manual intellectual assistance process.

In step 719, with the start of the manual intellectual assistance process, this process starts. This process operates in parallel to the PC main process shown in FIG. 7. That is, the process of step 719 proceeds to the process of step 701 without waiting for the end of the manual intellectual assistance process after the manual intellectual assistance process starts.

The control section 100 of the PC 10 creates a set of status IDs from the records of the status table 1081, performs a process of sorting the records of the set of status IDs in the order of start times (step 2201), and displays the result of the process on the display section 106 of the PC 10 (step 2203).

Here, in step 2203, the entire statuses 2505 are displayed in a contracted format, and specifically, only the titles of the processing operations indicated by the status IDs are displayed (see the display format of the PC print operation in FIG. 25).

In step 2205, in the display format displayed through the process of step 2203, a radio button 2507 (see FIG. 25) of the head record (the record sorted in the head in step 2201) of the status 2505 displayed at the uppermost position (PC print in FIG. 25) is set to ON with the initial setting (step 2205).

In the state in which the processes up to step 2205 are performed after the manual intellectual assistance process starts (step 719), the control section 100 waits until a user manipulates by the use of the operation section 104 (step 2207).

In the wait state (step 2207), when the user input an instruction by the use of the operation section 104, the control section 100 determines whether the instruction is to press an expanded icon 2501 (see FIG. 23) (step 2209).

Here, when the input instruction is to press the expanded icon 2501 (step 2209: YES), the record information of the status 2505 corresponding to the pressed expanded icon 2501 is displayed in a list format in response to the sorting process of step 2201 (step 2211) and the expanded icon 2501 of the expanded status 2505 is changed to a contracted icon 2503 (step 2213).

The processes of steps 2211 and 2213 are specifically described with reference to FIG. 25. In case of the PC fax transmission operation, the status 2505 is displayed along with the expanded icon 2501, similarly to the PC print operation, before the expanded icon 2501 is pressed (step 2209) (in other words, the list (records) is not displayed).

In this state, when the process of step 2209 is performed to the expanded icon 2501 for the PC fax transmission (step 2209: YES), the records of which the status IDs are marked “FPT” in the status table 1081 are displayed in the format shown in FIG. 25 in the sorting order of step 2201 (step 2211), and the expanded icon 2501 associated with the PC fax transmission is changed to the contracted icon 2503 (step 2213: the display is changed from “+” to “−”). At the time of first ending the process of step 2213, the process of step 2205 is valid, and all the radio buttons 2507 are set to OFF in the records displayed associated with the PC fax transmission.

On the other hand, in the wait state of step 2207, when the input instruction is not to press the expanded icon 2501 (step 2209: NO), but to press the contracted icon 2503 (step 2215: YES), the display in the PC fax transmission format shown in FIG. 25 is changed to the PC print format. That is, the display of the record list of the corresponding status 2505 is erased (step 2217) and the contracted icon 2503 is changed to the expanded icon 2501 (step 2219).

In the wait state of step 2207, when the input instruction is not to press the contracted icon 2503 (step 2215: NO), but to press the radio button 2507 (step 2221: YES), the radio button 2507 set to ON for a predetermined record (the head record of the uppermost status 2505 in the initial state) is changed to OFF (step 2223) and the radio button 2507 corresponding to the user's manipulation is set to ON (step 2225).

After the processes of step 2213, 2219, and 2225 are performed, the control section waits in step 2207 until the user's manipulation is performed.

Here, in the wait state of step 2207, when the instruction input by the user's manipulation is not to press any one of the expanded icon 2501, the contracted icon 2503, and the radio button 2507 (steps 2209, 2215, and 2221: NO), the process shown in FIG. 23 is performed.

That is, the control section 100 of the PC 10 determines whether the instruction input by the user's manipulation is the end of the manual intellectual assistance process, specifically, whether a closing button 2817 is pressed (step 2301). When it is YES (step 2301: YES), the process ends.

On the contrary, when the instruction is not to press the closing button 2517 (step 2301: NO), the instruction is to press a list display button 2509, a memory storage button 2511, an all display button 2513, or an all print button 2515. Accordingly, in order to perform the processes corresponding to the buttons, the records of which the radio button is set to ON (status ID, GID, destination address, target document) are read (step 2303).

The GID search condition setting process (step 2305) and the document search process (step 2307) are performed on the basis of the read information, and then the process of step 2309 is performed. Both processes performed in steps 2305 and 2307 are similar to the GID search condition setting process (step 1303) and the document search process (step 1305) performed in the during-activation intellectual assistance process (step 711), and thus description thereof is omitted.

In step 2309, it is determined whether the instruction, which is input through the user's manipulation of the operation section 104 and which results in the performing of the process of step 2303 is to press the list display button 2509.

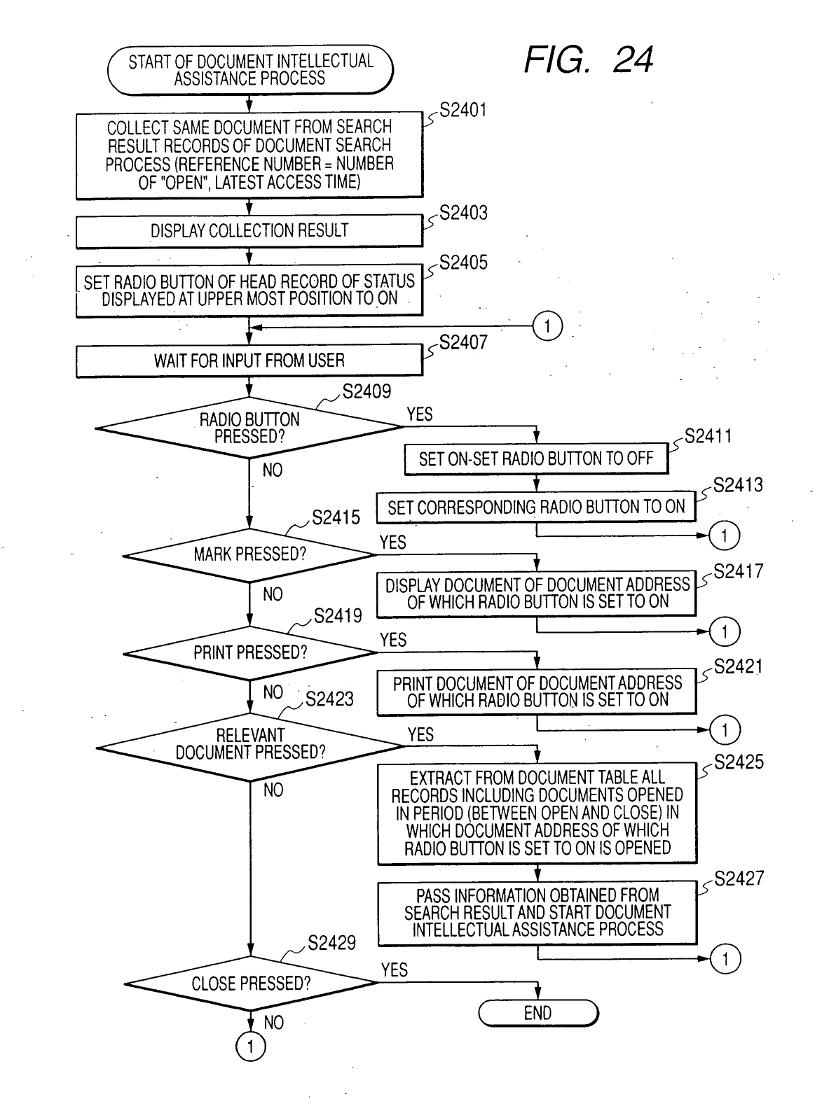

When the instruction is to press the list display button 2509 (step 2309: YES), the document intellectual assistance process is activated by the use of the result of the document search process of step 2307 (step 2311). The details of the document intellectual assistance process are described later with reference to FIG. 24.

On the contrary, when the instruction is not to press the list display button 2509 (step 2309: NO), it is determined whether the instruction is to press the memory storage button 2511 (step 2313). When it is YES (step 2313: YES), the control section 100 instructs the multifunction machine 20 to write the document data of the document address described in the search result record obtained through the document search process (step 2307) to a removable media 2101, and transmits the corresponding document data from the storage section 108 to the multifunction machine 20 through the communication section 102. On the other hand, the control section 200 of the multifunction machine 20 writes the corresponding document data received through the communication section 214 in response to the instruction to the removable media 2101 (step 2315).

When the instruction is not to press the memory storage button 2511 (step 2313: NO), it is determined whether the instruction is to press the all display button 2513 (step 2317) When it is YES (step 2317: YES), the control section 100 opens the document data of the document address described in the search result record obtained through the document search process (step 2307), and sequentially displays the contents on the display section 106 with a predetermined interval of time, for example, 2 seconds (step 2319).

When the instruction is not to press the all display button 2513 (step 2317: NO), it is determined whether the instruction is to press the all print button 2515 (step 2317). When it is YES (step 2317: YES), the control section 100 transits the document data of the document address described in the search result record obtained through the document search process (step 2307) to the multifunction machine 20 through the communication section 102, and allows the recording section 202 of the multifunction machine 20 to print the document data (step 2323)

When the instruction is not to press the all print button 2515 (step 2321: NO), a process corresponding to the press is performed or it is determined that the press is erroneous. Then, the control section waits until the user's manipulation is performed (step 2207).

When the processes of steps 2311, 2315, 2319, and 2323 are finished, the control section waits in step 2207 until the user's input is performed.

FIG. 24 is a diagram illustrating a flow of the document intellectual assistance process started in step 2311. FIG. 26 is a diagram illustrating a display format of information displayed on the display section 106 of the PC 10 at the time of performing the document intellectual assistance process.

First, in step 2401, the control section 100 of the PC 10 collects the number of reference to the document data (the number of records of which the event is “open”) of the same document address and the final access time (time described in the latest record) from the search result records obtained through the document search process (step 2307) by the use of the records comprising the same document address (step 2401), and then performs the process of step 2403.

In step 2403, the collection result is displayed in the format shown in FIG. 26 on the display section 106. At this time, the radio button of the head record among the displayed records is set to ON (step 2405).

Here, in the state in which the processes up to step 2605 are performed after the document intellectual assistance process starts (step 2311), the control section 100 waits until the user manipulates the operation section 104 (step 2407).

In the wait state (step 2407), when the user input an instruction through the operation section 104, the control section 100 determines whether the input instruction is to press the radio button 2601 (see FIG. 26) (step 2409). When it is YES (step 2409: YES), the process of step 2401 is performed.

In step 2407, the radio button 2601 set to ON in a predetermined record (the head record in the initial state) is set to OFF (step 2411) and the radio button 2601 corresponding to the user's manipulation is set to ON (step 2413).

On the other hand, when it is determined in step 2409 that the input instruction is not to press the radio button 2601, it is determined whether the input instruction is to press the display button 2603 (step 2415). When it is YES (step 2415: YES), the process of step 2417 is performed.

In step 2417, the document data of the document address in which the radio button is set to ON is opened and displayed on the display section 106.

When it is determined in step 2415 that the input instruction is not to press the display button 2603, it is determined whether the input instruction is to press the print button 2605 (step 2419). When it is YES (step 2419: YES), the process of step 2421 is performed.

In step 2421, the control section 100 reads the document data of the document address, in which the radio button is set to ON, from the storage section 108 and transmits the document data to the multifunction machine 20 through the communication section 102, and the recording section 202 of the multifunction machine 20 prints the document data.

When it is determined in step 2419 that the input instruction is not to press the print button 2605, it is determined whether the input instruction is to press a relevant document button 2607 (step 2423). When it is YES (step 2423: YES), the process of step 2425 is performed.

In step 2425, all the records of which the event is “open” in the period (between open and close) when the document data of the document address in which the radio button 2601 is set to ON are opened are extracted from the document table 1081 (step 2725).

Specifically describing the process with reference to FIG. 26, since the document data stored at the document address “file:/###/###/###2” comprises the number of reference of r2, the document data are opened r2 times. Accordingly, the extraction is performed to all the r2 periods.

When the period when the document data of the document address in which the radio button 2601 is set to ON is determined, the identity of the user (operator in FIG. 4) is considered.

The document intellectual assistance process starts again with respect to the search result records obtained through the extraction process of step 2425 (step 2427).

That is, the user can sequentially see documents associated with a document by performing the document intellectual assistance process.

When it is determined in step 2423 that the input instruction is not to press the relevant document button 2607, the control section 100 determines whether the input instruction is to press the closing button 2609 (step 2429). When it is YES (step 2429: YES), the control section ends the document intellectual assistance process (step 2311) and waits in step 2207 until the user's manipulation is performed.

On the other hand, when it is determined that the input instruction is not to press the closing button 2609 (step 2429: NO), the control section performs a process corresponding to the press or determines that the press is erroneous, and waits until the user's manipulation is performed (step 2407).

After performing the processes of steps 2413, 2417, 2421, and 2427, the control section waits again in step 2407 until the user's input is performed.

(Process 2 of Information Management System)

Next, a process (2) of the information management system 1 comprising the above-mentioned configuration is described with reference to the drawings. The process (2) starts in parallel to the process (1).

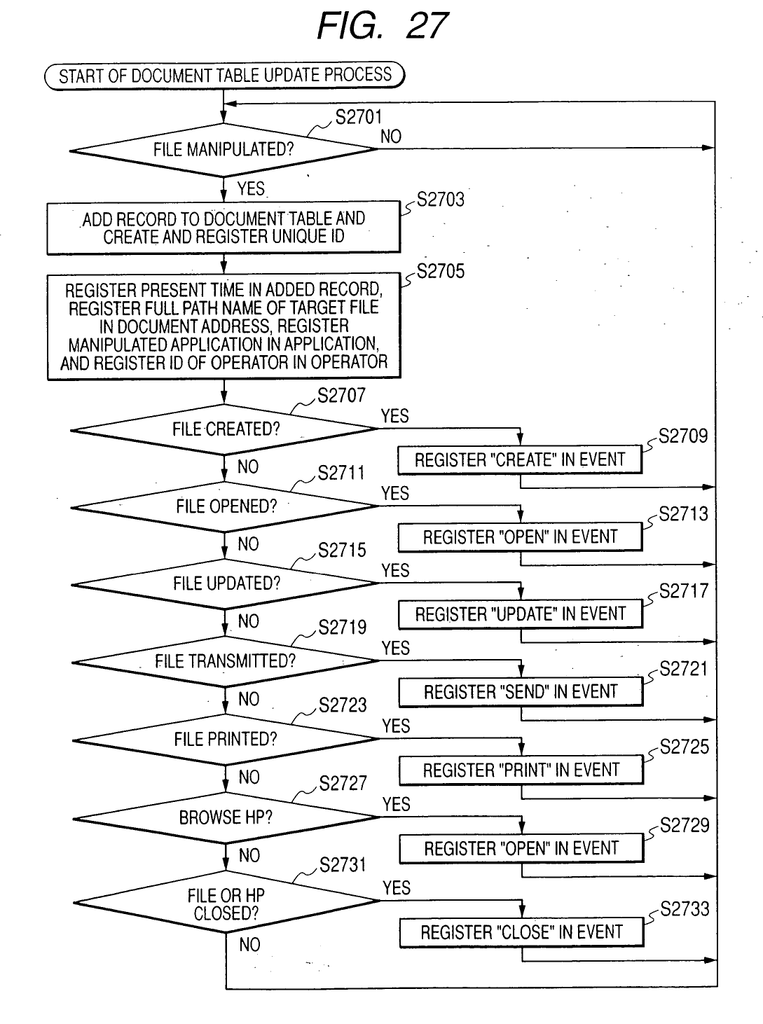

FIG. 27 is a diagram illustrating a flow of a process of updating the document table 1083 performed by the PC 10. The process (2) shown in the flow is performed by the control section 100 of the PC 10, and more specifically, is performed by the CPU of the control section 10 by the use of the program stored in the ROM or the like.

First, when the document data stored in the storage section 108 are manipulated by the use of the operation section 104 or the operation of the multifunction machine 20 is carried out, that is, when the target document data are transmitted to the PC 10 from the multifunction machine 20 by starting the processing operation (status) described as “(copied to PC)” among the items of the “target document address” of FIG. 3, the target document data are newly stored in the storage section 108, the RFID tags 322 and 324 of the books 32 and 34 are read by the RFID tag reading section 306 of the book sensor 30, and the information is transmitted to the PC 10 through the communication section 34, the control section 100 determines whether a homepage (hereinafter, referred to as “HP”) on Internet 70, which introduces the book 32 or the like associated with the transmission from the book sensor 30, is opened (hereinafter, the manipulations or processes are referred to as “file manipulation”) (step 2701).

When it is determined in step 2701 that the file manipulation is performed (step 2701: YES), the control section 100 adds a record to the document table 1083, creates an ID unique to the record, registers the unique ID (step 3003), and then performs the process of step 2705.

When it is determined in step 2701 that the condition is not satisfied (step 2701: NO), the control section waits until the file manipulation is performed.

In step 2705, the present time is registered to the record added in step 2703, registers a full path name of the target file to the document address, registers an application to the application, and registers the type of the operator to the operator.

Thereafter, a process of determining information to be registered to the “event” not yet registered is performed (steps 2707 to 2733).

First, the control section 100 determines whether the file manipulation performed in step 2701 is to store a new document file in the storage section 108 (hereinafter, referred to as “file creation” (step 2707). The control section registers “create” as an event, when the file manipulation is the file creation (step 2707: YES).

On the other hand, when the file manipulation is not the file creation (step 2707: NO), the control section determines whether the file manipulation is to open the document file stored in the storage section 108 (hereinafter, referred to as “file opening”) (step 2711). When it is YES (step 2711: YES), the control section registers “open” as an event (step 2713).

When it is not YES in step 2711 (step 2711: NO), it is determined whether the document data stored in the storage section 108 is updated (overwritten) (step 2715). When it is YES (step 2715: YES), “update” is registered as an event (step 2713).

When it is not YES in step 2715 (step 2715: NO), it is determined whether the document data stored in the storage section 108 is transmitted (the PC fax transmission is comprised) (step 2719). When it is YES (step 2719: YES), “send” is registered as an event (step 2721).

When it is not YES in step 2719 (step 2719: NO), it is determined whether the document data stored in the storage section 108 is printed (which corresponds to the status “PC fax transmission” in FIG. 3) (step 2719). When it is YES (step 2719: YES), “send” is registered as an event (step 2721).

When it is not YES in step 2715 (step 2715: NO), it is determined whether the document data stored in the storage section 108 is printed (the recording section 202 of the multifunction machine 20 is used) (step 2723). When it is YES (step 2723: YES), “print” is registered as an event (step 2725)

When it is not YES in step 2723 (step 2723: NO), it is determined whether the HP is opened (step 2727). When it is YES (step 2727: YES), “open” is registered as an event (step 2729).

When it is not YES in step 2727 (step 2727: NO), it is determined whether the file or HP is closed, which corresponds to the file opening (step 2711) or the HP opening (step 2727) (step 2731). When it is YES (step 2731: YES), “close” is registered as an event (step 2729).

When it is not YES in step 2731 (step 2731: NO), the control section 100 waits until a file manipulation is performed again, after finishing the process of step 2709, 2713, 2717, 2721, 2725, 2729, or 2733.

Hitherto, the “document data” have been mainly exemplified in the description according to the first illustrative aspect. however, the data as a target of the information management system 1 are not limited to the “document data”, but the same details (processes) may be performed to, for example, “image data”, “sound data”, other data, or mixtures of the data.

### SECOND EXAMPLE

Hereinafter, an information management system different from the first illustrative aspect will be described specifically.

A second illustrative aspect of the invention is different from the first illustrative aspect, in that the “GID” used in the first illustrative aspect is not provided, that is, the “GID” is not defined in FIG. 3 and the “GID search condition setting process” is not performed in the during-activation intellectual assistance process and the manual intellectual assistance process. Therefore, the details of the same configuration and process order are omitted but only differences are described in the following description (since the process order in the manual intellectual assistance process is similar to the during-activation intellectual assistance process, the during-activation intellectual assistance process is substantially described in the second illustrative aspect).

(During-Activation Intellectual Assistance Process)

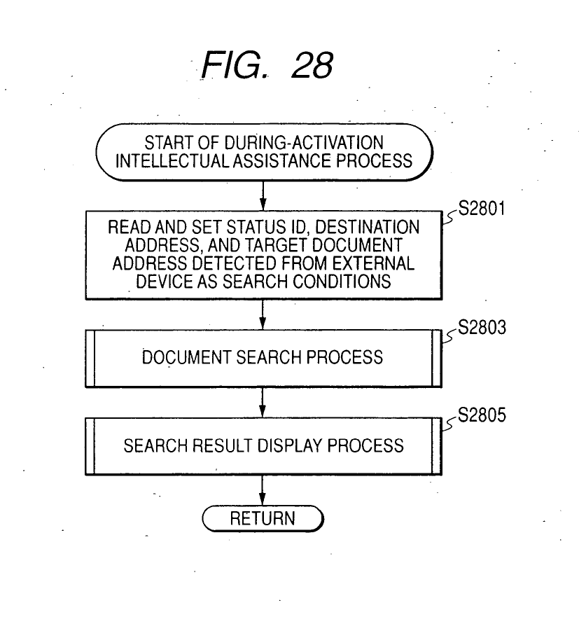

FIG. 28 is a diagram illustrating a flow of the during-activation intellectual assistance process.

When the during-activation intellectual assistance process is performed in step 711 of FIG. 7, the control section 100 of the PC 10 first reads the status ID, the destination address, and the target document address input (detected) by the external device from the RAM in step 709. The control section sets the data selected by the user through the operation section 104 as a search condition (step 2801), and performs the document search process (step 2803).

FIG. 15 is a diagram illustrating a flow of the document search process (step 2803). First, all the records in the status table 1081 and the document table 1083 are set to the initial values of the search result records (step 1501).

Next, in order to specify the target document associated with a specific record from the status table 1081, a search process is performed on the basis of the search condition selected in step 2803.

That is, in step 1503, it is determined whether the status ID is set as the search condition. When it is YES (step 1503: YES), the record corresponding to the status ID set as the search condition in the status table 1081 is stored as the search result record (step 1505) and the process of step 1507 is performed. When the status ID is not set as the search condition (step 1503: NO), the process of step 1507 is performed without performing the process of step 1505.

In step 1507, it is determined whether the destination address is added as the search condition. When it is YES (step 1507: YES), the record corresponding to the destination address designated as the search condition among the search result records stored in step 1505 is stored as the search result record (step 1509) and then the process of step 1511 is performed. In step 1507, when the destination address is not added as the search condition (step 1507: NO), the process of step 1511 is performed without performing the process of step 1509.

In step 1511, it is determined whether the target document address is added as the search condition. When it is determined that the target document address is set (step 1511: YES), the record corresponding to the target document address designated as the search condition among the search result records stored in step 1505 and the like is stored as the search result record (step 1513) and then the process of step 1515 is performed. When it is determined in step 1511 that the target document address is not added as the search condition (step 1511: NO), the process of step 1515 is performed without performing the process of step 1513.

Here, the search result records obtained through the processes of steps 1503 to 1513 will be described in more detail.

When it is YES in steps 1503, 1507, and 1511, the final search result records comprise the records in the same status table 1081 as being stored in step 1313.

When it is YES in steps 1503 and 1507 and it is NO in step 1511, the final search result records comprise the records in the same status table 1081 as being stored in step 1509.

When it is YES in steps 1503 and 1511 and it is NO in step 1507, the final search result records comprise the records in the same status table 1081 as being stored in step 1513.

When it is YES in step 1503 and it is NO in steps 1507 and 1511, the final search result records comprise the records in the same status table 1081 as being stored in step 1505.

When it is NO in step 1503 and it is YES in steps 1507 and 1511, the final search result records comprise the records in the same status table 1081 as being stored in step 1513.

When it is NO in steps 1503 and 1511 and it is YES in step 1507, the final search result records comprise the records in the same status table 1081 as being stored in step 1509.

When it is NO in steps 1503 and 1507 and it is YES in step 1511, the final search result records comprise the records in the same status table 1081 as being stored in step 1513.

When it is NO in steps 1503, 1507 and 1511, the search result records comprise the records in the same status as the status table 1081 set as an initial value in step 1501.

In step 1515, in order to perform the processes subsequent to step 1517, a non-processed search result record is read from the search result records specified in steps 1503 to 1513 and then the process of step 1517 is performed.

The processes after step 1517 are similar to those of the first illustrative aspect including the search result display process 2805, and thus details thereof are not described.

What is claimed is:

1. An information management device comprising:
a second storage unit that stores a plurality of utilization data;
a utilization unit that utilizes the utilization data stored in the second storage unit;
a specification unit that specifies a utilization time at which the utilization data are used by the utilization unit, utilization data specifying information for specifying the utilization data, and a process specifying information that specifies a processing operation performed for the utilization data;
a first storage unit that correlates and stores the utilization time, the utilization data specifying information, and the process specifying information specified by the specification unit;
a first extraction unit that extracts the same utilization data specifying information as that of the utilization data specifying information for specifying one utilization data, which is utilized by the utilization unit, from the first storage unit;
a second extraction unit that selectively extracts the process specifying information correlated with the utilization data specifying information extracted by the first extraction unit for each type of the processing operation;
a third extraction unit that extracts the same process specifying information as the process specifying information extracted by the second extraction unit from the first storage unit for each type of the processing operation; and
a correlation giving unit that correlates the utilization data specified by the utilization data specifying information, which is correlated with the utilization time extracted by the third extraction unit, with the one utilization data when the utilization time correlated with the process specifying information extracted by the third extraction unit is included in a period obtained by adding a first predetermined period to the utilization time correlated with the process specifying information extracted by the second extraction unit and a period obtained by retroacting a second predetermined period from the utilization time.

2. An information management system comprising:
an information management device that comprises:
a second storage unit that stores a plurality of utilization data;
a utilization unit that utilizes the utilization data stored in the second storage unit;
a specification unit that specifies a utilization time at which the utilization data are used by the utilization unit, utilization data specifying information for specifying the utilization data, and a process specifying information that specifies a processing operation performed for the utilization data;
a first storage unit that correlates and stores the utilization time, the utilization data specifying information, and the process specifying information specified by the specification unit;
a first extraction unit that extracts the same utilization data specifying information as that of the utilization data specifying information for specifying one utilization data, which is utilized by the utilization unit, from the first storage unit;
a second extraction unit that selectively extracts the process specifying information correlated with the utilization data specifying information extracted by the first extraction unit for each type of the processing operation;
a third extraction unit that extracts the same process specifying information as the process specifying information extracted by the second extraction unit from the first storage unit for each type of the processing operation; and
a correlation giving unit that correlates the utilization data specified by the utilization data specifying information, which is correlated with the utilizationtime extracted by the third extraction unit, with the one utilization data when the utilization time correlated with the process specifying information extracted by the third extraction unit is included in a period obtained by adding a first predetermined period to the utilization time correlated with the process specifying information extracted by the second extraction unit and a period obtained by retroacting a second predetermined period from the utilization time; and
an external device that is connected to the information management device in a communication-practicable manner and has a second output unit that performs a predetermined process,
wherein the information management device has a first output unit that outputs the utilization data correlated with the utilization data by the correlation giving unit when the second output unit outputs the utilization data.

3. The information management system according to claim 2, wherein the utilization data output by the first output unit of the information management device is output as address information from which the utilization data is specified and accessed, and the utilization data indicated by the address information is output in response to selection of the address information.

4. A computer usable medium having computer readable instructions stored thereon for enabling a computer to perform predetermined operations, the predetermined operations including the steps of:
storing a plurality of utilization data in a second storage unit;
utilizing the utilization data stored in the second storage unit;
specifying a utilization time at which the utilization data are used, utilization data specifying information for specifying the utilization data, and a process specifying information that specifies a processing operation performed for the utilization data;
first correlating and storing the specified utilization time, the utilization data specifying information, and the process specifying information;
first extracting the same utilization data specifying information as the utilization data specifying information for specifying one utilization data, which is utilized, from the first storage unit;
second extracting that selectively extracts the process specifying information correlated with the utilization data specifying information extracted by the first extracting for each type of the processing operation;
third extracting that extracts the same process specifying information as the process specifying information extracted by the second extracting from the first storage unit for each type of the processing operation; and
correlating the utilization data specified by the utilization data specifying information, which is correlated with the utilization time extracted by the third extracting, with the one utilization data when the utilization time correlated with the process specifying information extracted by the third extracting is included in a period obtained by adding a first predetermined period to the utilization time correlated with the process specifying information extracted by the second extracting and a period obtained by retroacting a second predetermined period from the utilization time.
